(19) United States
(12) Patent Application Publication
(10) Pub. No.: US 2011/0234802 A1
(43) Pub. Date: Sep. 29, 2011

(54) ON-VEHICLE LIGHTING APPARATUS

(75) Inventors: Masahiro YAMADA, Kobe-shi (JP); Azusa MATSUOKA, Kobe-shi (JP); Susumu TANIGUCHI, Kobe-shi (JP)

(73) Assignee: FUJITSU TEN LIMITED, KOBE-SHI (JP)

(21) Appl. No.: 13/045,117

(22) Filed: Mar. 10, 2011

(30) Foreign Application Priority Data
Mar. 25, 2010 (JP) 2010-070316

(51) Int. Cl. H04N 7/18

(52) U.S. Cl. 348/148; 348/E07.085

(57) ABSTRACT

In an image display system, respective light volumes of a plurality of light sources are individually adjusted according to surrounding areas of a vehicle indicated as subject images of display images on a display. Thus, only the light volumes of a necessary part of the light sources can be increased. Therefore, all of the plurality of light sources are not necessary to be emitted at maximum capacity constantly, so that consumed electric power can be reduced.

### BACKGROUND OF THE INVENTION

1. Field of the Invention

The invention relates to a technology of providing illumination for assisting in shooting of surrounding of a vehicle.

2. Description of the Background Art

Conventionally an image display system that is installed in a vehicle like an automobile and that displays images of surrounding of the vehicle taken by an on-vehicle camera on a display in a vehicle cabin is known. Utilizing the image display system helps a driver to grasp surrounding status of the vehicle on a real-time basis.

For example, outer region of a front fender on an opposite side of a driver's seat tends to be a blind spot. Therefore, the driver finds difficulty in grasping clearance between the car body and an obstacle. If the image display system is utilized, the image showing outer region of the front fender is acquired by the on-vehicle camera and then displayed on a display in the vehicle cabin. This helps the driver easily confirm clearance between the car body on the opposite side of a driver seat and the obstacle when the driver pulls the car to the side of the road or another car.

Such image display system can not obtain sufficient exposure for shooting in a dark surrounding environment, for example, at night, so that there is a case where the image that displays surrounding areas of the vehicle can not secure its brightness sufficiently. It is therefore suggested, in a relatively dark surrounding environment, an auxiliary light for assisting in shooting is emitted to light subject areas for the shooting to secure necessary brightness for the image.

By the way it is recently suggested that an image display system that displays a composite image indicating surrounding areas of a vehicle viewed from an arbitrary virtual viewpoint such as an overhead or a rear point of the vehicle by utilizing plural generated images of surrounding areas of a vehicle shot by plural on-vehicle cameras. The image display system can also display the image indicating entire surrounding areas of the vehicle on the display.

When utilizing such an image display system, it is desirable to light surrounding areas of a vehicle in a relatively dark surrounding environment. As the areas that can be displayed by the image display system expand, areas that shall be lighted by an auxiliary light expand in a relatively dark surrounding. For example, for lateral areas of a vehicle, relatively broad areas from the front to the rear of the vehicle need to be lighted by auxiliary lights.

On the other hand, artificial plants and stone walls and the like have property that is hard to reflect an auxiliary light. Therefore, there is a request for raising a volume of light of the auxiliary light to improve visibility of these objects that exist in the neighborhood of the vehicle.

However, if the volumes of light of the auxiliary lights are uniformly raised for entire areas to be lighted, the area is so broad that a large amount of electric power is required, which leads to high consumed electric power related to lighting by the auxiliary light. In addition, if the auxiliary light is constantly lighted with high volume of light, the degradation of the light source is promoted and its durability can be lowered.

### SUMMARY OF THE INVENTION

According to one aspect of the invention, an on-vehicle lighting apparatus provides illumination to assists an image-generating apparatus in shooting. The image-generating apparatus generates composite images including at least a part of surrounding areas of a vehicle which is viewed from virtual viewpoints, based on shot images obtained by shooting of the surrounding areas of the vehicle by plural cameras. The image-generating apparatus causes a display apparatus to display at least one image out of the shot images and the composite images as a display image. The on-vehicle lighting apparatus includes a plurality of light sources that respectively light plural areas obtained by dividing a particular area of the surrounding areas of the vehicle; and an adjusting unit that individually adjusts respective light volumes of the plurality of light sources according to the surrounding areas of the vehicle included in the display image.

The on-vehicle lighting apparatus individually adjusts respective light volumes of the plurality of light sources according to the surrounding areas of the vehicle included in the display image. Thus, only a light volume of a necessary part of the light sources can be increased. Therefore, all light volumes of the plurality of light sources are not necessary to be increased, so that consumed electric power related to lighting using an auxiliary light can be reduced.

According to another aspect of the invention, the adjusting unit increases a light volume of a part of the plurality of light sources from a standard light volume and decreases a light volume of another of the plurality of light sources from the standard light volume.

While consumed power can be reduced, a part of the particular area can be highlighted to be indicated to a user.

According to another aspect of the invention, the on-vehicle lighting apparatus further includes an obtaining unit that obtains brightness of the surrounding areas of the vehicle and the adjusting unit adjusts the respective light volumes of the plurality of light sources according to the brightness of the surrounding areas of the vehicle obtained by the obtaining unit.

Useless lighting is omitted and consumed power can be effectively reduced.

Therefore, the object of the invention is to reduce the consumed power related to lighting for assisting in shooting surrounding areas of a vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a block diagram of composition of an image display system;

FIG. 2 shows positions of on-vehicle cameras installed on a vehicle;

FIG. 3 shows external appearance of a side camera unit;

FIG. 4 shows a cross section diagram of a side camera unit viewed from a rear of a vehicle;

FIG. 5 shows a cross section diagram of a left side camera unit viewed from a left side of a vehicle;

FIG. 6 shows angles of optical axes of three light sources to a vehicle;

FIG. 7 shows another angles of the optical axes of the three light sources to a vehicle;

FIG. 8 is a drawing to explain a method for generating a composite image;

FIG. 9 shows transition of an operating mode of the image display system;

FIG. 10 shows positional transition of virtual viewpoints in a surrounding confirmation mode;

FIG. 11 shows an example of a display in the surrounding confirmation mode;

FIG. 12 shows transition of a display mode in a front mode;

FIG. 13 shows transition of a display mode in a back mode;

FIG. 14 shows a status where door mirrors are retracted;

FIG. 15 shows contents of a standard light volume table;

FIG. 16 shows contents of a light volume adjusting table;

FIG. 17 shows a process flow to adjust light volume of light sources in the first embodiment;

FIG. 18 shows state transition of screen in an own vehicle confirmation mode;

FIG. 19 shows state transition of virtual viewpoint;

FIG. 20 shows a process flow for adjusting light volumes of light sources in the second embodiment;

FIG. 21 shows an area which headlights of a vehicle can light;

FIG. 22 shows a process flow for adjusting light volumes of light sources in the third embodiment.

### DESCRIPTION OF THE EMBODIMENTS

Embodiments of the invention are described below referring to figures.

### 1. First Embodiment

<1-1. System Composition>

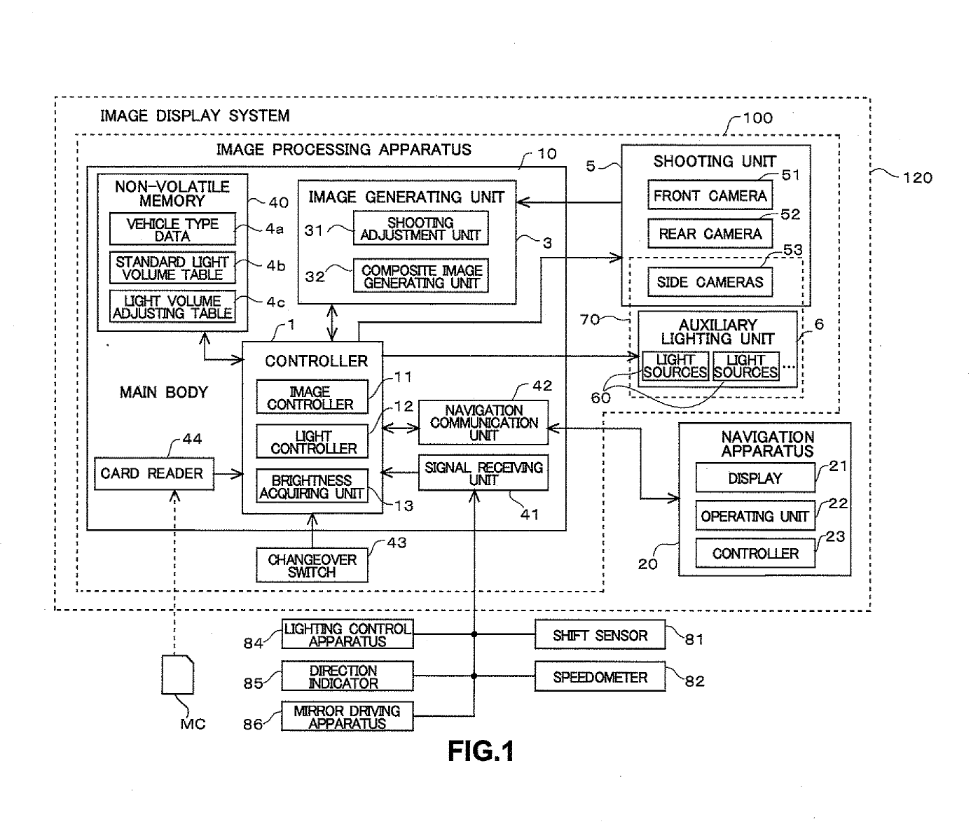

FIG. 1 is a block diagram of composition of an image display system 120 in the first embodiment. The image display system 120 to be installed in a vehicle (a car in the embodiment) has functions to shoot images of surrounding areas of the vehicle, generate the images and display them in the vehicle cabin. A user of the image display system 120 (a driver as a typical example) can grasp surrounding status of the vehicle on a real-time basis by utilizing the image display system 120.

As shown in FIG. 1, the image display system 120 mainly includes an image processing apparatus 100 that generates images for displaying the surrounding areas of the vehicle and a navigation apparatus 20 that displays information to a user who gets into a vehicle. The image generated by the image processing apparatus 100 is displayed on a navigation apparatus 20.

The navigation apparatus 20 for providing a navigation guidance to a user includes a display 21 like LCD with a touch panel function, an operating unit 22 that the user performs operation and a controller 23 that controls the whole apparatus. A navigation apparatus 20 is installed in an instrument panel and the like of the vehicle so that a screen of the display 21 can be seen from the user. Instructions from a user are received by the operating unit 22 and by the display 21 as a touch panel. The controller 23 is a computer having, for example, CPU, RAM and ROM and the like. Each function of the controller 23 including a navigation function is realized through processing operation performed by CPU according to predetermined programs.

The navigation apparatus 20 connected to the image processing apparatus 100 to communicate each other can send or receive each control signal to or from the image processing apparatus 100 or can receive images that are generated by the image processing apparatus 100. The display 21 usually displays images based on functions of the navigation apparatus 20 alone under the control of the controller 23, however, displays the images that show the surrounding status of the vehicle generated by the image processing apparatus 100 under the predetermined conditions. Thus, the navigation apparatus 20 functions also as a display apparatus that receives and displays the image generated by the image processing apparatus 100.

The image processing apparatus 100 includes a main body 10 that is ECU (Electronic Control Unit) with a function to generate images. The main body 10 is positioned at a predetermined location of the vehicle. The image processing apparatus 100 includes a shooting unit 5 that shoots an image of the surrounding areas of the vehicle and the apparatus 100 functions as an image-generating apparatus that generates a composite image, viewed from a virtual viewpoint, based on images obtained by shooting the surrounding areas of the vehicle.

The image processing apparatus 100 further includes an auxiliary lighting unit 6 that assists the shooting unit 5 in shooting and functions also as an on-vehicle lighting apparatus that assists the shooting unit 5 in shooting. The auxiliary lighting unit 6 includes a plurality of light sources 60 (six light sources 60 in the embodiment) that emit the auxiliary light that assists in the shooting of the shooting unit 5. In a dark surrounding environment, for example, at night, sufficient exposure can not be obtained in the shooting by the shooting unit 5, so that the shot image is not bright enough to display the surrounding areas of the vehicle. Therefore the auxiliary lighting unit 6 provides illumination.

Plural on-vehicle cameras of 51, 52 and 53 equipped with the shooting unit 5 and a plurality of light sources 60 equipped with the auxiliary lighting unit 6 are disposed on appropriate locations that are different from the location of the main body 10 in the vehicle. The detail will be described later.

The main body 10 of the image processing apparatus 100 mainly includes a controller 1 that controls the whole apparatus, an image generating unit 3 that generates display images after processing the images shot by the shooting unit 5 and a navigation communication unit 42 that communicates with the navigation apparatus 20.

User's instructions received by the operating unit 22 and the display 21 of the navigation apparatus 20 are received by the navigation communication unit 42 as control signals to be input into the controller 1. The image processing apparatus 100 includes a changeover switch 43 that receives user's instruction to switch the displayed contents. Signals representing user's instruction are input into the controller 1 also from the changeover switch 43. Thus, the image processing apparatus 100 can operate by responding to the user's operation of both the navigation apparatus 20 and the changeover switch 43. The changeover switch 43 is positioned at an appropriate location that is different from the location at which the main body 10 is disposed in a vehicle so that the user can operate it easily.

The image generating unit 3 is, for example, hardware circuit that allows various types of image processing and includes a shooting adjustment unit 31 and a composite image generating unit 32 as its main functions.

The shooting adjustment unit 31 adjusts the shot image by the shooting unit 5 to be used for display. Concretely, the adjustment unit 31 performs the image processing like distortion correction, zooming and cutout to the shot image.

The composite image generating unit 32 generates a composite image, viewed from arbitrary virtual viewpoints fixed in surrounding areas of the vehicle, displaying at least a part of surrounding areas of a vehicle based on plural shot images obtained by plural on-vehicle cameras of 51, 52 and 53 in the shooting unit 5. A method to generate the composite image by the composite image generating unit 32 will be described later.

A shot image adjusted by the shooting adjustment unit 31 and a composite image generated by the composite image generating unit 32 are further adjusted for the display image and then output into the navigation apparatus 20 by the navigation communication unit 42. Thus, an image that displays surrounding areas of the vehicle as a subject image is displayed on the display 21 of the navigation apparatus 20. The display image is at least one image out of the shot image and the composite image.

The controller 1 is a computer including, for example, CPU, RAM and ROM. Each control function of the controller 1 is realized through processing operation performed by CPU according to predetermined programs. An image controller 11, a light controller 12 and a brightness acquiring unit 13, shown in FIG. 1, represent a part of the functions of the controller 1 that is realized by the CPU as described above.

The image controller 11 controls an image processing performed by the image generating unit 3. For example, the image controller 11 designates various parameters and the like that is necessary to generate a composite image generated by the composite image generating unit 32.

The light controller 12 controls lighting by the auxiliary lighting unit 6. The light controller 12 can individually adjust the respective volumes of light of a plurality of light sources 60 included in the auxiliary lighting unit 6. Concretely, the light controller 12 decides the respective volumes of light of a plurality of light sources 60 and sends signals to the auxiliary lighting unit 6 so that the volume of the light of the auxiliary light emitted by each of the light sources 60 is equal to the determined one.

The brightness acquiring unit 13 acquires brightness of each pixel of four shot images that are acquired by four on-vehicle cameras of 51, 52 and 53 to derive the average brightness.

The main body 10 in the image processing apparatus 100 further includes a non-volatile memory 40, a card reader 44 and a signal receiving unit 41, which are connected to the controller 1.

The non-volatile memory 40 is, for example, flash memory that can maintain stored contents when power is off. The non-volatile memory 40 stores vehicle type data 4a, a standard light volume table 4b and a light volume adjusting table 4c and the like. The vehicle type data 4a are data corresponding to vehicle type that are necessary when the composite image generating unit 32 generate composite images. The standard light volume table 4b and the light volume adjusting table 4c are table data that the light controller 12 refers to when deciding the light volumes of the plurality of light sources 60 of the auxiliary lighting unit 6.

The card reader 44 reads a memory card MC that is a portable recording medium. The card reader 44 includes a removable card slot for the memory card MC and reads recorded data in the memory card MC set in the card slot. The data read by the card reader 44 are input into the controller 1.

The memory card MC includes flash memory and the like that can store various data. The image processing apparatus 100 can utilize various data stored in the memory card MC. For example, by reading out stored programs in the memory card MC, programs realizing functions of the controller 1 (firmware) can be updated. In addition, by storing vehicle type data in the memory card MC corresponding to vehicle type that are different from the vehicle type data 4a stored in the non-volatile memory 40 and then read this out to store in the non-volatile memory 40, the image display system 120 can correspond to different types of vehicles.

The signal receiving unit 41 receives signals from each apparatus that is installed in a vehicle. Signals coming from the outside of the image display system 120 are input into the controller 1 via the signal receiving unit 41. Concretely, signals representing various types of information that are sent from a shift sensor 81, a speedometer 82, a lighting control apparatus 84, a direction indicator 85 and a mirror driving apparatus 86, etc. are received by the signal receiving unit 41 and then input into the controller 1.

The shift sensor 81 sends information about operating positions of a shift lever of gear shift in the vehicle, that is, signals representing shift lever positions such as “P (parking),” “D (drive),” “N (neutral),” “R (reverse)” or others. The speedometer 82 sends signals representing a driving speed (km/h) of the vehicle 9 at the time.

The lighting control apparatus 84 controls a normally-installed driving lighting system that is different from the auxiliary lighting unit 6 and is used during regular driving of the vehicle. The driving lighting system includes headlights, parking lights, tail lights, brake lights, backup lights, etc. The lighting control apparatus 84 turns the headlights and the parking lights on in response to an operation by a driver, and when it turns the headlights or the parking lights on, it also turns the tail lights on. The lighting control apparatus 84 turns the brake lights on when the driver presses a brake pedal and it turns the backup lights on when the shift lever is in a position of “R.” The lighting control apparatus 84 sends out signals representing a lighting status of the driving lighting system.

The direction indicator 85 sends out direction indication based on an operation of indicator switch, that is, turn signals representing the direction of a direction indication given from a driver of the vehicle (right or left turn, or direction of turning a car around). When the indicator switch is operated, the turn signals are generated to indicate the operated direction (right or left direction). When the indicator switch returns to the neutral position, the turn signals are turned off.

The mirror driving apparatus 86 opens and retracts door mirrors of the vehicle in response to driver's operations. The mirror driving apparatus 86 sends signals representing the status of the door mirrors.

<1-2. Shooting Unit and Auxiliary Lighting Unit>

Next the shooting unit 5 and the auxiliary lighting unit 6 of the image processing apparatus 100 are described in detail. The shooting unit 5 and the auxiliary lighting unit 6 are electrically connected to the controller 1 and operated based on signals from the controller 1.

The shooting unit 5 includes a front camera 51, a rear camera 52 and side cameras 53. These on-vehicle cameras of 51, 52 and 53 respectively include image sensor such as CCD and CMO etc. and electronically capture images.

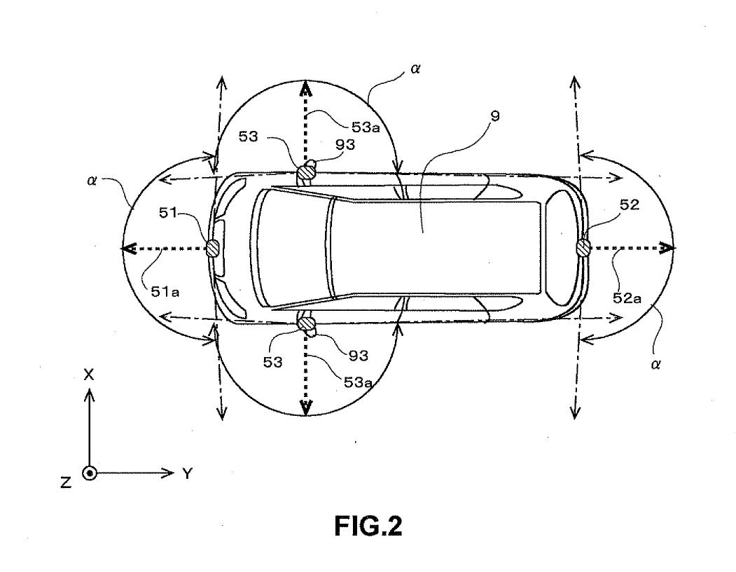

FIG. 2 shows positions where on-vehicle cameras of 51, 52 and 53 are installed on the vehicle 9. In addition, in the following description, a three dimensional XYZ rectangular coordinates shown in the figure are appropriately used when the direction is indicated. The XYZ-axis is relatively fixed to the vehicle 9. A width direction of the vehicle 9 is referred to as an X-axis direction, a direction in which the vehicle 9 travels (longitudinal direction of the vehicle 9) is referred to as a Y-axis direction and a vertical direction of the vehicle 9 is referred to as a Z-axis direction. For convenience, the right side of the vehicle 9 is referred to as +X, the backside of the vehicle 9 is referred to as +Y, and the upper side of the vehicle 9 is referred to as +Z.

The front camera 51 is disposed in the neighborhood of the mounting position of a license plate in the front end of the vehicle 9 with its optical axis 51a headed in a direction in which the vehicle 9 travels (−Y side in the direction of Y-axis in a planar view). The rear camera 52 is disposed in the neighborhood of the mounting position of a license plate in the rear end of the vehicle 9 with its optical axis 52a headed in the direction opposite to the one in which the vehicle 9 travels (+Y side in the direction of Y-axis in a planar view). Moreover, the side cameras 53 are respectively disposed on right and left door mirrors 93, with their optical axes 53a headed outward in line with a width direction of the vehicle 9 (x-axis direction in a planar view). The mounting positions of the front camera 51 and the rear camera 52 are desirable to be at substantial center between opposite sides of the width of the vehicle 9; however, the positions may be somewhat off the center in a width direction.

These on-vehicle cameras of 51, 52 and 53 adopt lenses such as fish-eye lens so that they have an angle of a view α of 180 degrees or more. Thus, using these four on-vehicle cameras of 51, 52 and 53 enables a shooting of an entire circumference of the vehicle 9.

Referring back to FIG. 1, the six light sources 60 included in the auxiliary lighting unit 6, for example, are LEDs that emit invisible near-infrared light or the like. Since the near-infrared light is invisible to human beings, even when the light sources 60 of the auxiliary lighting unit 6 lights the surrounding areas of the vehicle 9, it has no effect on walkers and other people around the vehicle 9. On the other hand, the image sensors adopted for the on-vehicle cameras of 51, 52 and 53 sense near-infrared light. In a case where the vehicle 9 is in a relatively dark surrounding environment, the near-infrared auxiliary light as the auxiliary light from the light sources at the auxiliary lighting unit 6 lights an area surrounding the vehicle 9. Therefore, images with sufficient brightness enough to show a situation of the lit area can be captured with no effect on walkers and other people.

Three light sources out of six light sources 60 of the auxiliary lighting unit 6 are disposed on the left side of the vehicle 9 and the rest three of the light sources 60 are disposed on the right side of the vehicle 9. The three light sources 60 on the left side of the vehicle 9 respectively light plural areas obtained by dividing a lateral area on the left side of the vehicle 9. On the other hand, the three light sources 60 on the right side of the vehicle 9 respectively light plural areas obtained by dividing a lateral area on the right side of the vehicle 9.

The three light sources 60 on the left side of the vehicle 9 and the side camera 53 on the left side of the vehicle 9 are accommodated in the same housing and integrated in a side camera unit 70 as a whole. Similarly, the three light sources 60 on the right side of the vehicle 9 and the side camera 53 on the right side of the vehicle 9 are accommodated in the same housing and integrated in the side camera unit 70 as a whole.

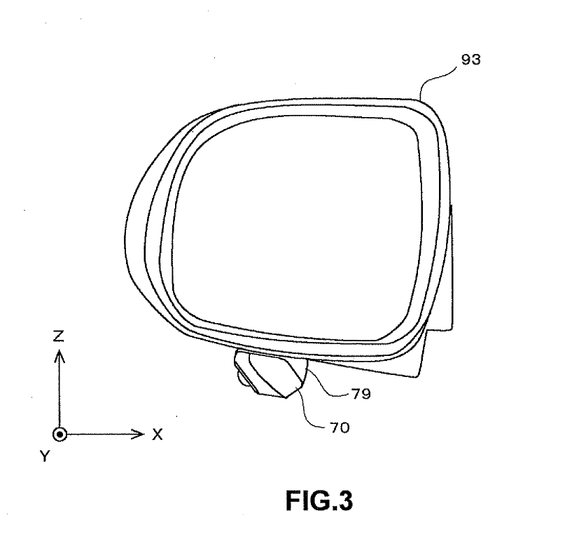

FIG. 3 is a figure showing composition of outer appearance of the side camera unit 70. In addition, the composition and disposition of the side camera unit 70 are symmetrical in a width of the vehicle 9. Therefore the left side of the vehicle 9 is concretely described in the following description; however, the same applies to the right side thereof. As shown in the figure, the side camera unit 70 is disposed at the lower side of the door mirror 93 via a bracket 79.

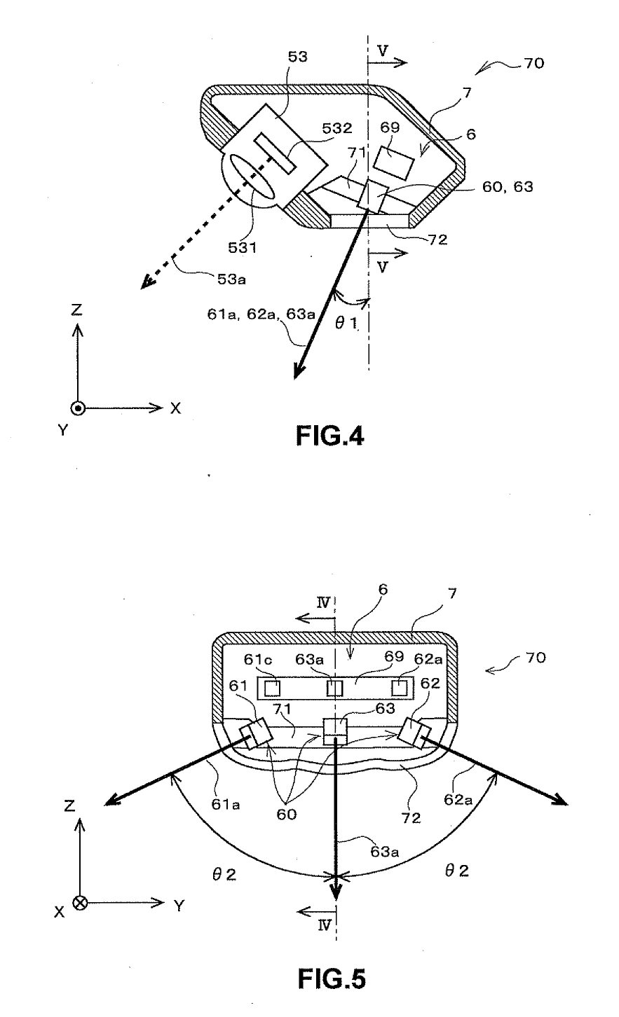

FIG. 4 is a cross-sectional view including X and Z axis of the left side camera unit 70 viewed from the backside of the vehicle 9 (+Y side). FIG. 5 is a cross-sectional view including Y and Z axis of the left side camera unit 70 viewed from the left side of the vehicle 9 (−X side). FIG. 4 is a cross-sectional view of FIG. 5 along the line IV-IV. FIG. 5 is a cross-sectional view of FIG. 4 along the line V-V.

As shown in these figures, the side camera unit 70 includes a housing 7 as its outer casing. The housing 7 accommodates the side camera 53, three light sources 60 of the auxiliary lighting unit 6 and a light source driving unit 69. The three light sources 60 are concretely a front light source 61 that mainly lights areas of the forward side of the vehicle 9, a rear light source 62 that Mainly lights areas of backward side of the vehicle 9 and a central light source 63 that mainly lights interacted areas lit by both the front light source 61 and the rear light source 62.

The light source driving unit 69 provides electric power from a battery of the vehicle to these three light sources 60. The light source driving unit 69 includes three current changing units 61a, 62a and 63a corresponding to the front light source 61, the rear light source 62, and the central light source 63 respectively. Each of current changing unit 61a, 62a and 63a can change values of current that flow into the corresponding light sources 61, 62 and 63. The light volumes of the light sources 60 depend on current values, so that the light volumes of the three light sources 61, 62 and 63 are individually changed by such changes of current values. The light volume of each light source 61, 62 and 63 is designated by signals from the light controller 12 of the controller 1.

The side camera 53 includes a lens 531 and an image sensor 532. As shown in FIG. 4, the side camera 53 is disposed in the housing 7 with its optical axis 53a headed outward from the vehicle 9. The side camera 53 is fixed to the housing 7 so that the direction of this optical axis 53a is angled at a predetermined angle to vertical direction (ex. approximately 45 degrees).

The three light sources 60 of the auxiliary lighting unit 6 are disposed on the inner side (+X side) than the side camera 53 in the housing 7. Optical axes 61a, 62a and 63a of the three light sources 61, 62 and 63 are headed outward from the vehicle 9 and all their directions are angled at predetermined angle θ1 to vertical direction viewed from the longitudinal direction of the vehicle 9 (Y-axis direction). The angle θ1 is desirable to be less than 30 degrees, for example.

As shown in FIG. 5, the central light source 63 is disposed in the center of the housing 7 and the front light source 61 and the rear light source 62 are disposed symmetrically to the center of the housing 7. Viewed from the width direction of the vehicle 9 (X-axis direction), the direction of the optical axis 63a of the central light source 63 corresponds to vertical direction (Z-axis direction), the direction of the optical axis 61a of the front light source 61 tilts to the forward side of the vehicle 9 (−Y side) and the direction of the optical axis 62a of the rear light source 62 tilts to the backward side of the vehicle 9 (+Y side). In addition, the direction of the optical axis 61a of the front light source 61 and the direction of the optical axis 62a of the rear light source 62 are set to be symmetrical to the direction of the optical axis 63a of the central light source 63. That is, the angle between the optical axis 63a of the central light source 63 and the optical axis 61a of the front light source 61 corresponds to the angle between the optical axis 63a of the central light source 63 and the optical axis 62a of the rear light source 62 and the angle is predetermined angle θ2. The angle θ2 is desirable to be 60 degrees or more or 70 degrees or less, for example.

The three light sources 60 of the auxiliary lighting unit 6 are fixed to the housing 7 by the fixing member 71 so that the light sources 60 are to be positioned at the described positions and directions in the foregoing. That is, the three light sources 60 are fixed to the housing 7 with each optical axis headed to different directions. A section of the housing 7 corresponding to the bottom of the fixed positions of these light sources 60 adopts a light-permeable member 72 that permeates near-infrared light. Therefore, the auxiliary light of the light sources 60 can light the outside the housing 7.

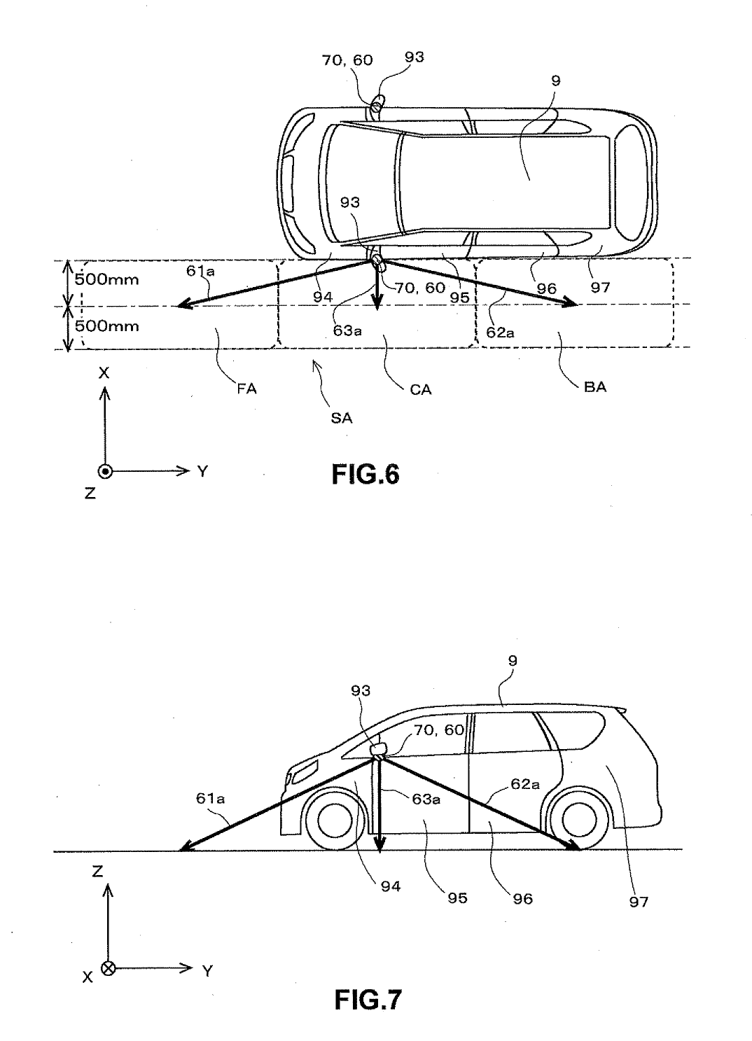

FIG. 6 and FIG. 7 show positional relations of optical axes of the three light sources 60 in the left side camera unit 70 to the vehicle 9. FIG. 6 is a top view (viewed from +Z side) and FIG. 7 is an edge view (viewed from −X side).

As shown in these figures, the optical axes 61a, 62a and 63a of the three light sources 60 extend from the side camera unit 70 mounted at the door mirror 93 to the position that is 500 mm away from the side of the vehicle 9 in the X direction. The directions of the optical axes 61a, 62a and 63a of the three light sources 60 are respectively different. Concretely, in a planar view (refer to FIG. 6), the direction of the optical axis 63a of the central light source 63 corresponds to a width direction of the vehicle 9 (X-axis direction), the direction of the optical axis 61a of the front light source 61 tilts to the forward side of the vehicle 9 (−Y side) and the direction of the optical axis 62a of the rear light source 62 tilts to the backward side of the vehicle 9 (+Y side). In addition, in a lateral view (refer to FIG. 7), the direction of the optical axis 63a of the central light source 63 corresponds to a vertical direction of the vehicle 9 (Z-axis direction), the direction of the optical axis 61a of the front light source 61 tilts to the forward side of the vehicle 9 (−Y side) and the direction of the optical axis 62a of the rear light source 62 tilts to the backward side of the vehicle 9 (+Y side). The direction of the optical axis 61a of the front light source 61 and the direction of the optical axis 62a of the rear light source 62 are set to be symmetrical to the direction of the optical axis 63a of the central light source 63.

Under these arrangements of optical axes, lateral area SA of intended lighting area are divided and lit by the three light sources 61, 62 and 63. In the lateral area SA to be lit, particular area that is relatively fixed to the vehicle 9 is set. Concretely, the lateral area SA in the longitudinal direction of the vehicle 9′(Y-axis direction) is an area from approximately two meters ahead of the front end of the vehicle 9 to approximately the rear end of the vehicle 9. The lateral area SA in the width direction of the vehicle 9 (X-axis direction) is an area that is one meter outward from the lateral side of the vehicle 9.

The three light sources respectively light the intended lighting areas of plural areas FA, BA and CA which divide the lateral area SA. Concretely the front light source 61 mainly lights FA, an area ahead of the front end of the vehicle 9 (hereinafter referred to as “front area”), in the lateral area SA intended to be lit. The rear light source 62 mainly lights BA, outer area in the neighborhood of a rear door 96 and a rear fender 97 (hereinafter referred to as “rear area”) of the vehicle 9, in the lateral area SA intended to be lit. The central light 63 mainly lights CA, outer area in the neighborhood of a front fender 94 and of a front door 95 of the vehicle 9 between the front area FA and the rear area BA, in the lateral area SA intended to be lit.

The central light source 63 lights relatively nearer area from the position where the side camera unit 70 is disposed (position where the three light sources 60 are disposed) than the front light source 61 and the rear light source 62. Thus, if the light volume of the central light source 63 is the same level with the one of the front light source 61 and the rear light source 62, the central area CA in the lateral area SA is lit with more brightness than other areas of FA and BA, so that it is conceivable that the overall brightness of the lateral area SA becomes un-uniform. Therefore, the central light 63 is controlled so that the light volume becomes lower than the front light source 61 and the rear light source 62. As a result the overall lateral area SA from the front area to the rear area of the vehicle 9 is uniformly lit.

As described above, in the embodiment, the three light sources 60 that light the lateral area SA in the same side of the vehicle 9 is fixed and housed in the same housing 7 with their optical axes having different directions. The three light sources 60 are integrated in the housing 7 as the side camera unit 70. Thus, only mounting the side camera unit 70 allows a plurality of light sources 60 to be mounted at a time. In addition, only installing wiring to the side camera unit 70 is enough for electric wirings to the three light sources 60 such as power line and control line. Therefore, a plurality of light sources 60 light the relatively broad area of lateral area SA of the vehicle 9 can be mounted with convenience and at low costs.

<1-3. Generation of Composite Image>

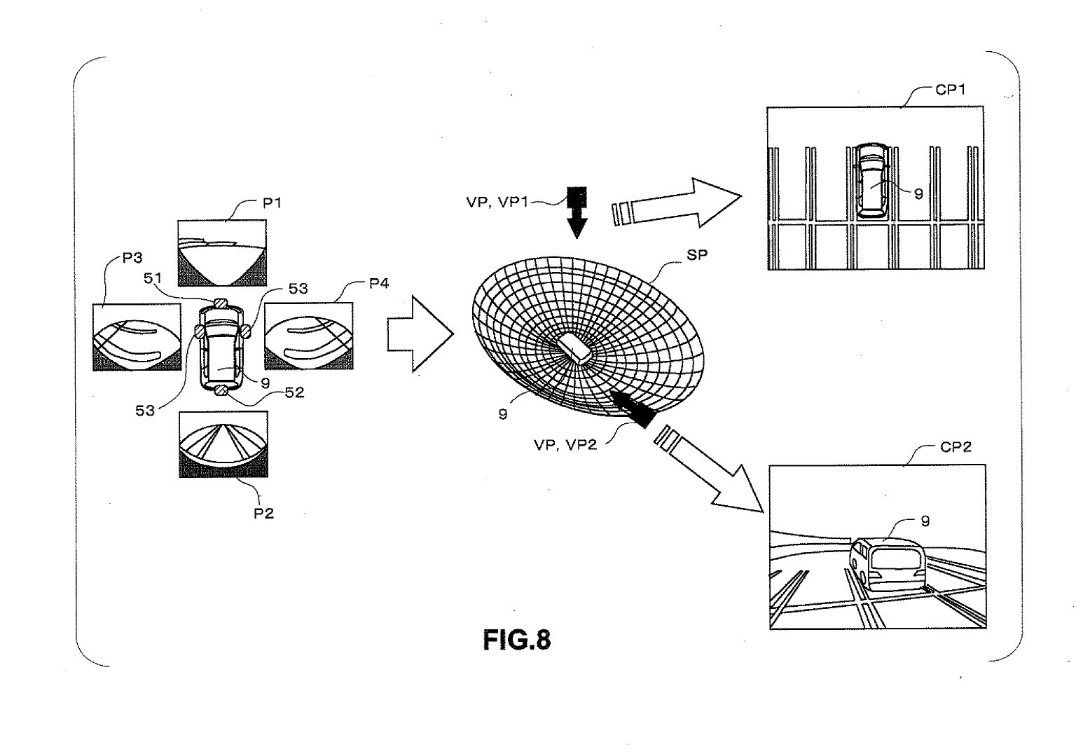

Next described is a method where the composite image generating unit 32 of an image generating unit 3 generates a composite image of at least a part of surrounding areas of the vehicle 9 viewed from arbitrary virtual viewpoints based on plural shot images captured by the shooting unit 5. When a composite image is generated, the vehicle type data 4a, stored in the non-volatile memory 40 in advance, are used. FIG. 8 is a drawing to explain a method for generating a composite image.

When the front camera 51, the rear camera 52, and the side cameras 53 of the shooting unit 5 shoot simultaneously, the shooting unit 5 captures four shot images P1, P2, P3 and P4 that respectively shows images ahead of, on the right and left sides of, and behind the vehicle 9. In other words, it means that the four shot images P1, P2, P3 and P4 captured by the shooting unit 5 include information of an entire circumference of the vehicle 9 of a time of shooting.

Next, individual pixels at the four shot images P1, P2, P3 and P4 are projected on a virtual three-dimensional curved surface SP. An exemplary shape of the three-dimensional curved surface SP is substantially hemispherical (a shape of a bowl), and a center of the substantial hemisphere (a bottom of the bowl) is defined as a position of the vehicle 9. A correspondence between positions of individual pixels included in the shot images P1, P2, P3 and P4 and positions of individual pixels included in the curved surface SP is predetermined. Therefore, values of the individual pixels of the curved surface SP can be determined based on the correspondence relation and the values of the individual pixels included in the shot images P1, P2, P3 and P4.

The correspondence between positions of the individual pixels included in the shot images P1, P2, P3 and P4 and positions of the individual pixels included in the curved surface SP depends on the position of the four on-vehicle cameras of 51, 52 and 53 of the vehicle 9 (distance between cameras, ground clearance and degree of optical axis etc.). Thus the data table representing the correspondence relation is included in the vehicle type data 4a stored in the non-volatile memory 40.

Polygon data representing shapes and sizes of vehicles included in the vehicle type data 4a are utilized, whereby a vehicle image of a polygon model representing the three-dimensional shape is virtually composed. The composed vehicle image is disposed at the center of the substantial hemisphere that is defined as a position of the vehicle 9 in a three-dimensional space where curved surface SP is set.

Further, in the three-dimensional space where the curved surface SP exists, a virtual viewpoint VP is set by the controller 1. The virtual viewpoint VP is determined by view position and view direction and then is fixed at an arbitrary view position with an arbitrary view direction corresponding to the surrounding areas of the vehicle 9 in the virtual three-dimensional space.

A necessary area on the curved surface SP is cut out as an image according to the fixed virtual viewpoint VP. The relation between the virtual viewpoint VP and the necessary area on the curved surface SP is predetermined and stored in a data table in the predetermined non-volatile memory 40 and the like. On the other hand, the vehicle image composed of polygons corresponding to the set virtual viewpoint VP is rendered, so that the two-dimensional vehicle image is superimposed on the cut out image. Therefore, a composite image that displays the vehicle 9 and at least a part of surrounding areas of the vehicle viewed from arbitrary virtual viewpoint is generated.

For example, when the virtual viewpoint VP1 is fixed at the point right above the approximate center of the vehicle 9 and in downward view direction on the substantial vertical line, a composite image CP1 that shows the vehicle 9 (actually the vehicle image) and the surrounding areas of the vehicle viewed from right-above is generated. Moreover, as shown in the figure, when the virtual viewpoint VP2 is fixed with the view position of posterior left of the vehicle 9 and with the view direction of substantial front of the vehicle 9, a composite image CP2 that shows the vehicle 9 (actually the vehicle image) and surrounding areas of the vehicle 9 viewed from posterior left of the vehicle 9 is generated.

Values of all the pixels of the curved surface SP do not need to be determined to actually generate a composite image. A processing speed can be faster by determining values of pixels of only the necessary areas corresponding to the virtual viewpoint VP based on the shot images P1, P2, P3 and P4.

<1-4. Operating Mode>

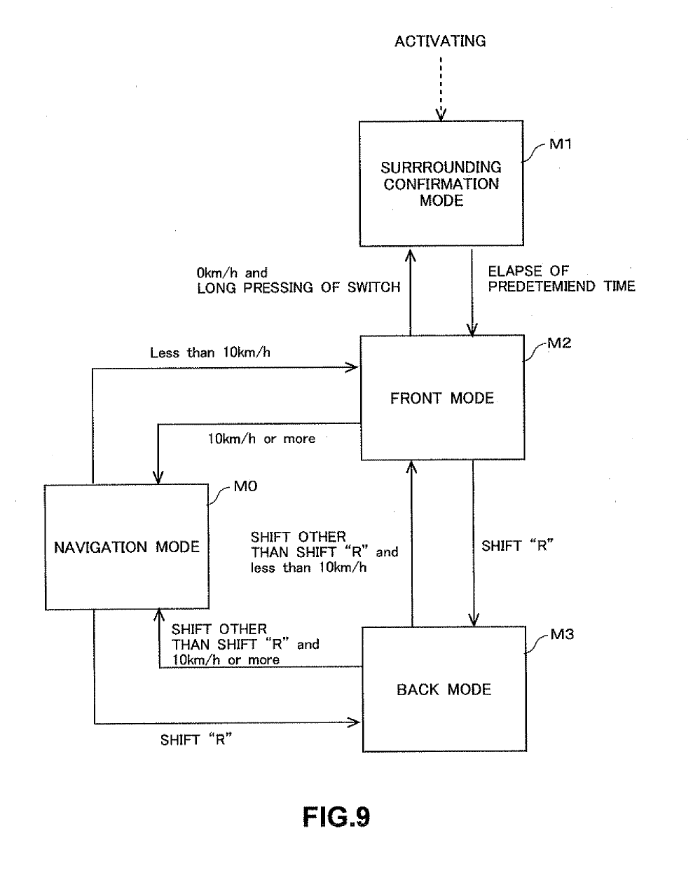

Next described is an operating mode of the image display system 120. FIG. 9 describes transition of the operating mode of the image display system 120. The image display system 120 has four operating modes: a navigation mode M0, a surrounding confirmation mode M1, a front mode M2 and a back mode M3. These operating modes can be changed by the control of the controller 1 according to driver's operations and driving status of the vehicle 9.

The navigation mode M0 is an operating mode that displays map images and the like for navigation guidance on the display 21 by the function of the navigation apparatus 20. In the navigation mode M0, functions of the image processing apparatus 100 are not utilized and each image is displayed by functions of the navigation apparatus 20 alone. Therefore, when the navigation apparatus 20 has a function for receiving signals of television broadcast to display it, televisions images are sometimes displayed instead of the map images for the navigation guidance.

Meanwhile, the surrounding confirmation mode M1, the front mode M2 and the back mode M3 are operating modes that show the surrounding status of the vehicle 9 on a real-time basis by displaying at least one image out of shot images and composite images as a display image on the display 21 through the functions of the image processing apparatus 100.

The surrounding confirmation mode M1 is an operating mode expressing images in animated motion where a viewpoint moves like orbiting the vehicle 9 viewing from above The front mode M2 is an operating mode that displays an image for mainly showing the front and the lateral areas of the vehicle 9, which is necessary when the vehicle moves forward. The back mode M3 is an operating mode that displays an image for mainly showing the area behind the vehicle 9, which is necessary when the vehicle moves backward.

When the image display system 120 is activated, the surrounding confirmation mode M1 appears. In the surrounding confirmation mode M1, when predetermined time elapses (for example 6 seconds) after the animation where a viewpoint moves like orbiting the vehicle 9 is shown, the mode automatically is changed to the front mode M2. In addition, in the front mode M2, when the changeover switch 43 is pressed down for predetermined time or more with the running speed of 0 km/h (stopped status), the mode is changed into the surrounding confirmation mode M1. In addition, it is possible to change the operating mode from the surrounding confirmation mode M1 to the front mode M2 by driver's instruction.

In the front mode M2, when the running speed becomes 10 km/h or more, for example, the operating mode is changed into the navigation mode M0. On the contrary, in the navigation mode M0, when the running speed represented by signals from the speedometer 82 becomes 10 km/h or less, for example, the operating mode is changed into the front mode M2.

When the running speed of the vehicle 9 is relatively high, the front mode M2 is canceled to make the driver concentrate on driving. On the contrary, when the running speed of the vehicle 9 is relatively low, there are many cases where the driver drives the car with paying much attention to the surrounding areas of the vehicle 9, for example, an entry into a crossing with bad visibility, a direction change and a pulling over and the like. Therefore, when the running speed is relatively low, the operating mode is changed from the navigation mode M0 to the front mode M2. In this case, another condition that there is driver's explicit operating instruction can be added to the condition that the running speed is 10 km/h or less.

In the navigation mode M0 or the front mode M2, when the position of the shift lever representing signals from the shift sensor 81 is R (reverse), the operating mode is changed into the back mode M3. That is, when a gear shifting lever of the vehicle 9 is positioned at “R (reverse)”, the vehicle 9 is in a status to move backward, and the operating mode is changed into the back mode M3 indicating the area behind the vehicle 9.

On the other hand, in the back mode M3, when the position of the shift level is other than “R (reverse)”, the mode is changed into the navigation mode M0 or the front mode M2 based on the running speed at the time. That is, when the running speed is 10 km/h or more, the mode is changed into the navigation mode M0 and when the running speed is 10 km/h or less, the mode is changed into the front mode M2.

Hereinafter, displayed forms of the surrounding areas of the vehicle 9 are described in detail in the surrounding confirmation mode M1, the front mode M2 and the back mode M3 respectively.

<1-5. Surrounding Confirmation Mode>

First, described is a displayed form of the surrounding areas of the vehicle 9 in the surrounding confirmation mode M1. The mode has only one display mode. In the surrounding confirmation mode M1, a composite image showing area of the entire circumference of the vehicle 9 is displayed as a subject image, where the virtual viewpoint VP continuously moves to express the animation.

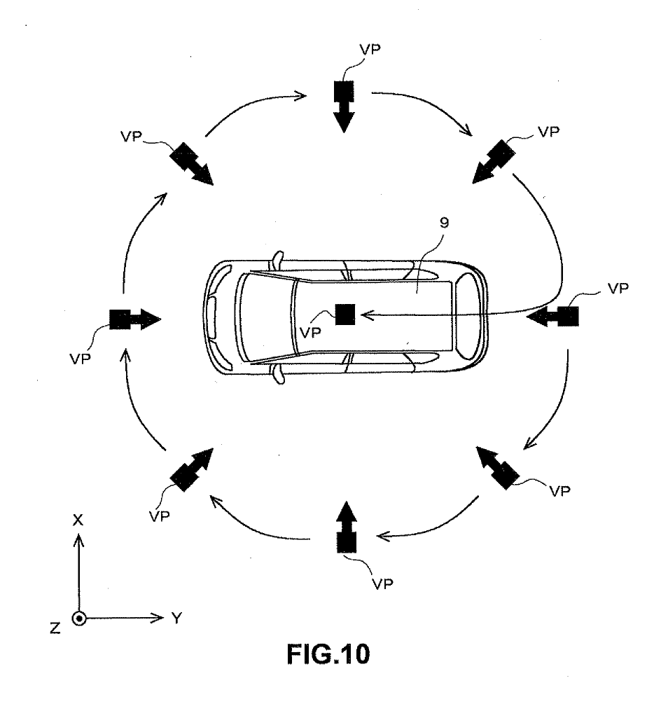

Concretely, the virtual viewpoint VP is set so that the vehicle 9 is viewed from above and as shown in FIG. 10, the virtual viewpoint VP continuously moves like orbiting the surrounding areas of the vehicle 9. The virtual viewpoint VP is first set behind the vehicle 9 before orbiting the surrounding areas of the vehicle 9 clockwise. Thus, the virtual viewpoint VP moves to the left side of, ahead of, on the right and behind the vehicle 9 and then moves to right above the vehicle 9. Plurality of composite images are continuously generated by moving the virtual viewpoint like this. The generated plurality of composite images is output into the navigation apparatus 20 sequentially and displayed on the display 21 continuously.

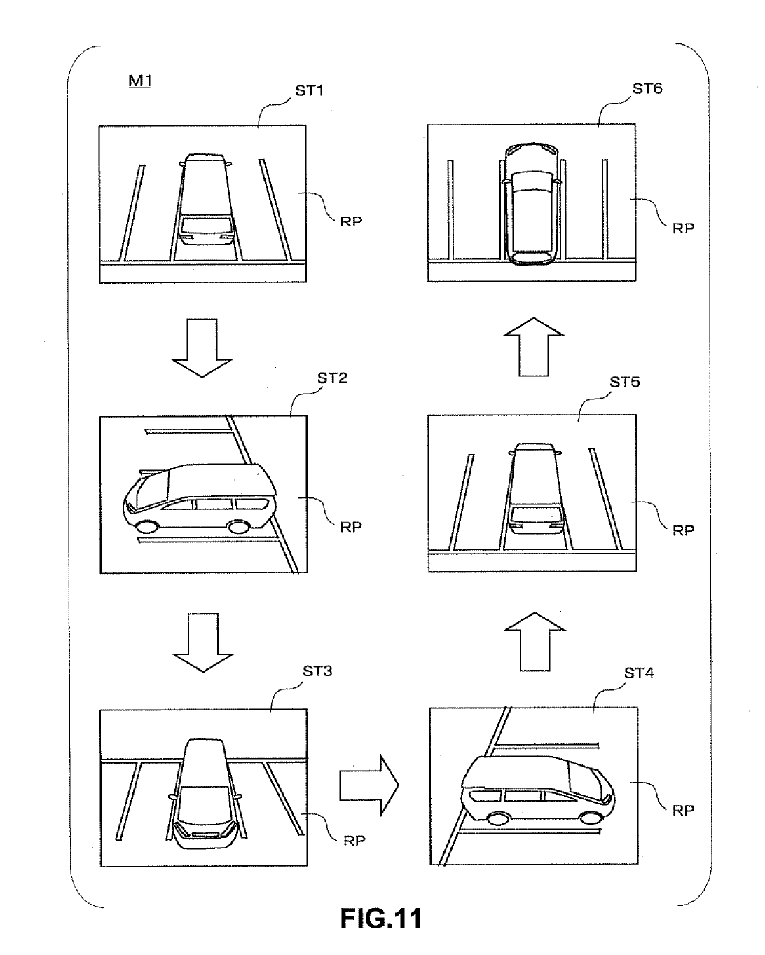

Thus, as shown in FIG. 11, the animation where a viewpoint moves like orbiting the vehicle 9 is shown with a status viewed from right-above the vehicle 9. In an example shown in FIG. 11, a composite image RP is displayed sequentially in an order of state ST1 to ST6. In each composite image RP, the vehicle 9 is disposed at the approximate center of the image, so that the status of the vehicle 9 and the surrounding areas of the vehicle 9 can be confirmed.

User views such animation in the surrounding confirmation mode M1, thereby confirming the entire circumference of the vehicle 9 from a viewpoint ahead of the vehicle 9. Therefore, the user can instinctively understand the positional relations between obstacles in the entire circumference of the vehicle 9 and the vehicle 9.

<1-6. Front Mode>

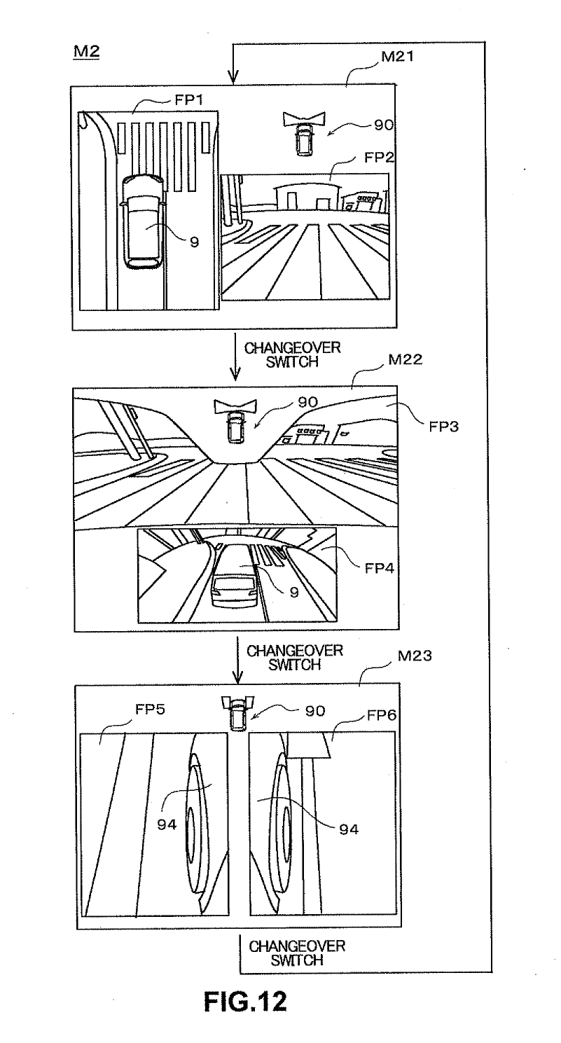

Next, described is a displayed form of the surrounding areas of the vehicle 9 in the front mode M2. FIG. 12 shows transition of a display mode in the front mode M2. The front mode M2 has three display modes of a driving bird-eye view mode M21, an own vehicle confirmation mode M22 and a side camera mode M23. These display modes are respectively different in display form. That is, different display modes have different types of display images, so that different areas of the surrounding areas of the vehicles are shown to a user in each display mode. A viewing guide 90 indicating the viewing range in each display form is displayed in these screens, which explicate a user which area of the surrounding areas of the vehicle 9 is displayed.

These display modes change in the order of the driving bird-eye view mode M21, the own vehicle confirmation mode M22 and the side camera mode M23 every time the user presses the changeover switch 43. When the switchover switch 43 is pressed in the side camera mode M23, it is set to be back to the driving bird-eye view mode M21 again.

The driving bird-eye view mode M21 is a display mode that displays the screen including a composite image FP1 viewed from the virtual viewpoint VP right-above the vehicle 9 and a front image FP2 as the shot image obtained by the shooting of the front camera 51 on the display 21. That is, in the driving bird-eye view mode M21, two display images, a composite image FP1 showing the entire surrounding areas of the vehicle 9 as a subject image and a front image FP2 showing the front area of the vehicle 9 as a subject image, are displayed on the same screen.

In the driving bird-eye view mode M21, these two images of FP1 and FP2 can be viewed, so that a user can confirm the road conditions ahead of the vehicle 9 in the traveling direction at a glance. The driving bird-eye view mode M21 is a display mode that is available with high versatility at various scenes while the vehicle is moving forward.

The own vehicle confirmation mode M22 is a display mode that displays the screen including a front image FP3 as the shot image obtained by the shooting of the front camera 51 and a composite image FP4 showing the surrounding areas of the vehicle viewed from the virtual viewpoint VP behind the vehicle 9 on the display 21. That is, in the own vehicle confirmation mode M22, two display images, a front image FP3 showing the front area of the vehicle 9 as a subject image and a composite image FP4 showing the lateral areas of the vehicle 9 as a subject image are displayed on the same screen.

The front image FP3 in the own vehicle confirmation mode M22 has wider viewing range in width direction compared with the front image in the driving bird-eye view mode M21. Thus, when the vehicle enters into a crossing with bad visibility, objects that exist ahead of and on the right and left sides of the front edge of the vehicle 9, which tend to be a blind spot, can be seen.

The composite image FP4 in the own vehicle confirmation mode M22 has the virtual viewpoint VP with the position moved to the backward of the vehicle 9 compared with the composite image FP1 in the driving bird-eye view mode M21 so that the lateral areas of the vehicle 9 becomes easy to be confirmed although the displayed backward area of the vehicle 9 becomes smaller. Therefore, the driver can easily see clearance in a case of going by an oncoming car.

In the own vehicle confirmation mode M22, these two images of FP3 and FP4 can be viewed, so that a user can see the situation of the areas to be confirmed at a glance when the user needs the careful driving like entering into a crossing with bad visibility and going by an oncoming car.

The side camera mode M23 is a display mode that displays the screen including side images of FP5 and FP6 as the shot images that are obtained by the shooting of right and left side cameras 53. The side images FP5 and FP6 are display images showing only area outside the front fender 94 that tend to be a blind spot form the driver seat.

In the side camera mode M23, these two images of FP3 and FP4 can be viewed, so that a user can easily see the situation of the areas to be confirmed when pulling the car to the side of the road.

<1-7. Back Mode>

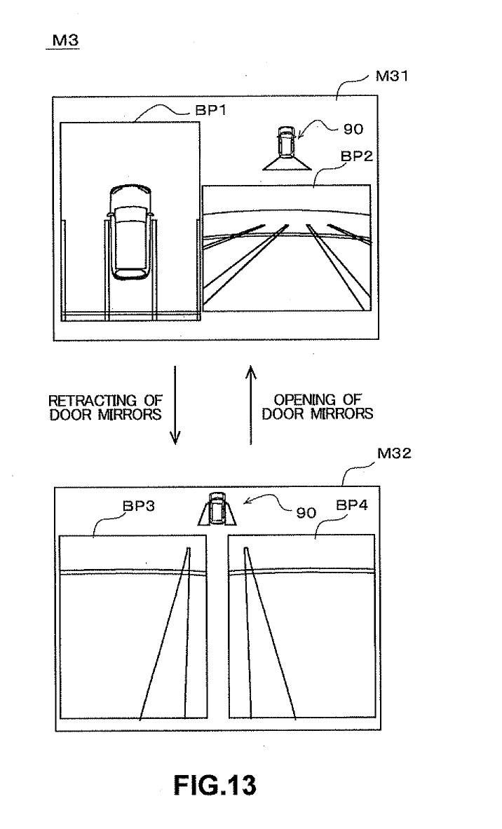

Next, described is a displayed form of the surrounding areas of the vehicle 9 in the back mode M3. FIG. 13 shows transition of a display mode in the back mode M3. The back mode M3 has two display modes, a parking bird-eye view mode M31 and a door mirror mode M32. These display modes are respectively different in display form. That is, different display modes have different types of display images, so that different areas of the surrounding areas of the vehicles are shown to a user in each display mode. These screens also display the viewing guide 90 indicating the viewing range in each display form, which explicates a user which area of the surrounding areas of the vehicle 9 is displayed.

These display modes can be changed by the control of the controller 1 according to the status of the door mirror 93 representing the signals from a mirror driving apparatus 86. Concretely, when the door mirror 93 is opened in a normal status, the mode becomes the parking bird-eye view mode M31 and when the door mirror 93 is refracted, the mode becomes the door mirror mode M32.

The parking bird-eye view mode M31 is a display mode that displays the screen including a composite image BP1 showing the status of the vehicle 9 viewed from the virtual viewpoint VP right-above the vehicle 9 and a rear image BP2 as the shot image obtained by the shooting of the rear camera 52 on the display 21. That is, in the parking bird-eye view mode M31, two display images, the composite image BP1 showing the surrounding areas of the vehicle 9 as a subject image and the rear image BP2 showing the area behind the vehicle 9 as a subject image are displayed on the same screen.

In the parking bird-eye view mode M31, these two images of BP1 and BP2 can be viewed, so that a user can see at a glance the situation of the areas behind the vehicle in the direction where the vehicle moves. The parking bird-eye view mode M31 is a display mode that is available with high versatility at various scenes while the vehicle is moving backward.

The door mirror mode M32 is a display mode that displays the screen including side images of BP3 and BP4 side-by-side as the shot images obtained by right and left side cameras 53 on the display 21. When the door mirror 93 is opened, the side images BP3 and BP4 are display images showing almost the same range that the door mirror 93 covers. Concretely, they are display images showing the rear area of the lateral areas of the vehicle 9.

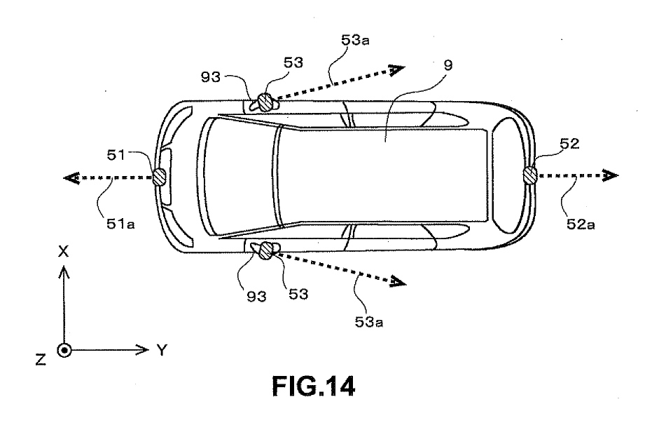

As shown in FIG. 14, the side cameras 53 are installed at the door mirror 93, so that its optical axis 53a is headed to rear side of the vehicle 9 when the door mirror 93 is retracted. Under the situation, the side cameras 53 can not obtain the image showing the entire lateral areas of the vehicle 9. Therefore, the composite image viewed from the arbitrary virtual viewpoint is difficult to be generated. However, the optical axis 53a is shifted to the rear side of the vehicle 9, the shot image of the rear areas of the lateral areas of the vehicle 9 can be obtained with relatively less distortion. In the door mirror mode M32, two side images BP3 and BP4 including the rear area of the lateral areas of the vehicle 9 as subject images are generated and displayed by utilizing this disposition of the side cameras 53.

In the door mirror mode M32, these two images of BP3 and BP4 can be viewed, so that the user can see almost the same range that the door mirrors 93 cover when the door mirror 93 needs to be retracted depending on the parking conditions.

<1-8. Adjustment of Light Volume of Light Sources>

In this image display system 120, the status of the surrounding areas of the vehicle 9 is shown to the display 21 in each display mode with different display form. When the surrounding environment is relatively dark and the image that displays surrounding areas of the vehicle 9 can not secure its brightness sufficiently, an auxiliary light by the auxiliary lighting unit 6 is emitted.

To improve the visibility of the objects displayed on the display image (subject images), the light volume of the auxiliary light needs to be high. However, if all of the plurality of light sources 60 of the auxiliary lighting unit 6 is constantly emitted at maximum capacity, electric power can be wasted. For example, even when the surrounding environment is dark, however, if it is somewhat bright by road lights and the like in the twilight, the image with sufficient brightness to display the surrounding areas of the vehicle can be captured with low auxiliary light volume. In addition, for example, in the side camera mode M23, it is necessary to make a user pay attention to the outside area of the front fender 94, so that the central area CA (refer to FIG. 6) corresponding to this area needs higher light volume of the auxiliary light, however, the necessity for the front area FA and the rear area BA to be emitted by higher light volume of the auxiliary light is low.

When all of the plurality of light sources 60 are constantly emitted with the maximum volume of light, the total value of electric current flown into the one side camera unit 70 becomes high. As a result, there is possibility that the costs of the electric wiring and electric parts increase in order to make the side camera unit 70 correspond to the high current. In addition, when all of the plurality of light sources 60 are constantly emitted with the maximum volume of light, the degradation of the light sources 60 is promoted and their durability can be lowered.

To correspond to such problems, in the image display system 120, respective light volumes of plurality of light sources 60 of the auxiliary lighting unit 6 can individually be adjusted according to the brightness of the surrounding areas of the vehicle and the display mode which is presently selected.

Concretely, the light volume as the control standard for each of a plurality of light sources 60 (hereinafter referred to as “standard light volume”) is determined based on the brightness of the surrounding areas of the vehicle. Then the light volumes are adjusted based on the respective standard light volume of the plurality of light sources 60 according to the display mode, whereby the light volume to be finally controlled (hereinafter referred to as “controlled light volume”) is set to be determined.

The correspondence relation between the brightness of the surrounding areas of the vehicle and the standard light volume is shown in the standard light volume table 4b stored in the non-volatile memory 40. In the standard light volume table 4b, the darker the brightness of the surrounding areas of the vehicle is, the standard light volume is set to be higher.

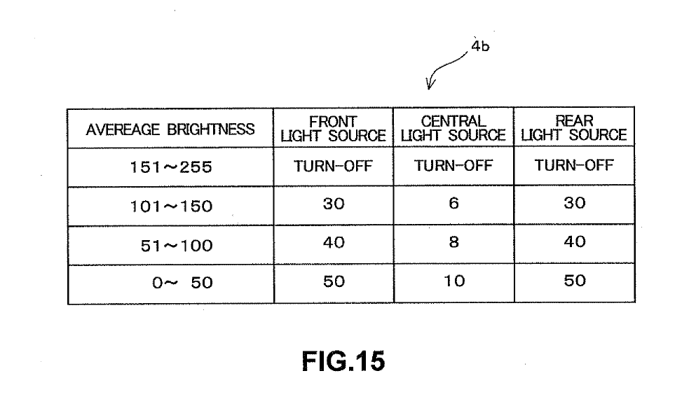

FIG. 15 shows the contents of the standard light volume table 4b. In the embodiment, the average brightness of the four shot images obtained by the four on-vehicle cameras of 51, 52 and 53 at the shooting unit 5 is utilized as values indicating the brightness of the surrounding areas of the vehicle. The average brightness is derived by the brightness acquiring unit 13 to be indicated in 8-bit (0 to 255).

The light volume emitted by the light sources 60 depends on current values flown into the light sources 60, so that, in the embodiment, the standard light volume of each of the light sources 60 is expressed in current values (mA) to be flown into the light sources 60 to make it the standard light volume. Hereinafter, the current value to be flown into the light sources 60 to make it the standard light volume is called “standard current value”.

As described above, the standard light volume of the central light source 63 (more properly, standard current value) is set low compared with the front light source 61 and the rear light source 62 so that the entire lateral area SA can be lit uniformly.

As shown in the standard light volume table 4b, when the average brightness, corresponding to the case where the surrounding environment is the darkest, is from “0 to 50”, the standard current value of the front light source 61, at the central light source 63 and the rear light source 62 is set to be 50 (mA), 10 (mA) and 50 (mA) respectively.

In addition, when the average brightness is from “51 to 100”, it is brighter in the surrounding environment compared with the case when the average brightness is from “0 to 50”. Thus, the standard current value is set low compared with the case when the average brightness is from “0 to 50”. Concretely, the standard current value of the front light source 61, at the central light source 63 and the rear light source 62 is set to be 40 (mA), 8 (mA) and 40 (mA) respectively.

Further, when the average brightness is from “101 to 150”, it is brighter in the surrounding environment compared with the case when the average brightness is from “51 to 100”. Thus, the standard current value is set low compared with the case when the average brightness is from “51 to 100”. Concretely, the standard current value of the front light source 61, of the central light source 63 and of the rear light source 62 is set to be 30 (mA), 6 (mA) and 30 (mA) respectively.

Further, when the average brightness is from “151 to 255”, it is sufficiently bright in the surrounding areas of the vehicle, so that all the light sources 60 are turned off.

When all the front light source 61, the central light source 63 and the rear light source 62 are emitted at the standard light volume set in the standard light volume table 4b, the entire lateral area SA can be uniformly lit. It is described in the light volume adjusting table 4c stored in the non-volatile memory 40 how the standard light volume set at each of the light sources 60 is adjusted to be the controlled light volume according to the display mode.

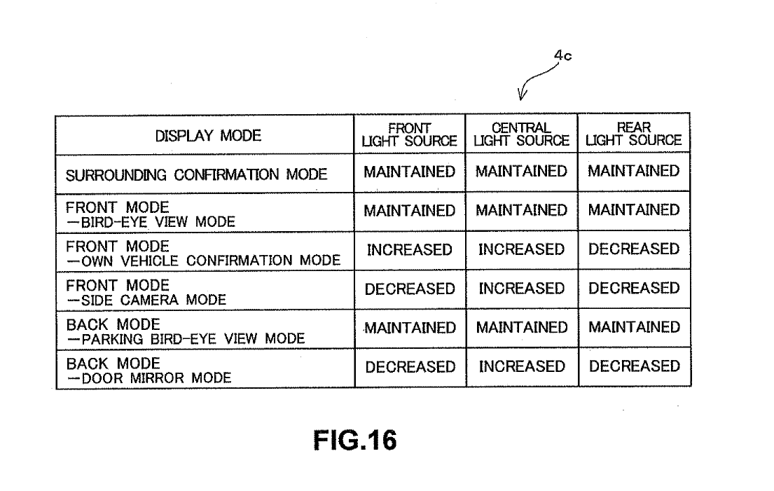

FIG. 16 shows the contents of the light volume adjusting table 4c. As described in the figure, the light volume adjusting table 4c describes how respective controlled light volumes of the front light source 61, the central light source 63 and the rear light source 62 are determined on each display mode. That is, for the light sources 60 whose controlled light volume shall be maintained to the standard light volume, “maintenance” is indicated, for the light sources 60 whose controlled light volume shall be increased from the standard light volume, “increase” is indicated, and for the light sources 60 where the controlled light volume shall be decreased from the standard light volume, “decrease” is indicated,

In the surrounding confirmation mode M1, “maintenance” is indicated for the front light source 61, the central light source 63 and the rear light source 62 respectively. The surrounding confirmation mode M1 is a display mode to confirm the entire circumference of the vehicle 9 (refer to FIG. 11), so that there are no special areas to call user's attention in the surrounding areas of the vehicle. Thus, the controlled light volume of all the light sources 60 is maintained at the standard light volume.

In the driving bird-eye view mode M21, “maintenance” is indicated for the front light source 61, the central light source 63 and the rear light source 62 respectively. The driving bird-eye view mode M21 shows the composite image FP1 that displays the entire surrounding areas of the vehicle 9 (refer to FIG. 12), so that there are no special areas to call user's attention in the surrounding areas of the vehicle. Thus, the controlled light volume of all the light sources 60 is maintained in the standard light volume.

In the own vehicle confirmation mode M22, “increase” is indicated for the front light source 61 and the central light source 63 and “decrease” is indicated for the rear light source 62. The own vehicle confirmation mode M22 is utilized when the user enters into a crossing with, bad visibility or goes by an oncoming car (refer to FIG. 12). Thus, to call user's attention to the forward side of the vehicle 9, the controlled light volumes of the front light source 61 and of the central light source 63 are increased from the standard light volume and the controlled light volume of the rear light source 62 is decreased from the standard light volume.

In the side camera mode M23, “increase” is indicated for the central light source 63 and “decrease” is indicated for the front light source 61 and for the rear light source 62. In the side camera mode M23, only areas outside the front fender 94 are displayed (Refer to FIG. 12). Thus, to call user's attention to the corresponding area, the controlled light volumes of the central light source 63 are increased from the standard light volume and the controlled light volumes of the front light source 61 and the rear light source 62 are decreased from the standard light volume.

In the parking bird-eye view mode M31, “maintenance” is indicated for the front light source 61, the central light source 63 and the rear light source 62 respectively. The parking bird-eye view mode M31 shows the composite image BP1 that displays the entire surrounding areas of the vehicle 9 (refer to FIG. 13), so that there are no special areas to call user's attention in the surrounding areas of the vehicle. Thus, the controlled light volume of all the light sources 60 are maintained in the standard light volume.

In the door mirror mode M32, “increase” is indicated for the central light source 63 and “decrease” is indicated for the front light source 61 and the rear light source 62. In the door mirror mode M32, rear area of the lateral areas of the vehicle 9 is displayed. (Refer to FIG. 13). However, the door mirror 93 is retracted, so that the direction of optical axes of the three light sources 60 are shifted to head to the rear side of the vehicle 9. Thus only the central light source 63 with its axis headed to the rear area of the lateral areas of the vehicle 9 has the increased controlled light volume from the standard light volume. Therefore, the controlled light volumes of the front light source 61 and the rear light source 62 respectively are decreased from the standard light volume.

To decide the controlled light volume like this actually means to decide the current value (hereinafter referred to as “controlled current value”) to be flown into the light sources 60 to make the value to be the controlled light volume. For the front light source 61 and the rear light source 62, the controlled current values are increased, for example, by 10 (mA) to the standard current value when “increase is indicated in the light volume adjusting table 4c and the controlled current values are decreased, for example, by 10 (mA) to the standard current value when “decrease” is indicated therein. For the central light source 63, the controlled current value is increased, for example, by 2 (mA) to the standard current value when “increase is indicated in the light volume adjusting table 4c and the controlled current value is decreased, for example, by 2 (mA) to the standard current value when “decrease” is indicated therein.

<1-9. Process Flow>

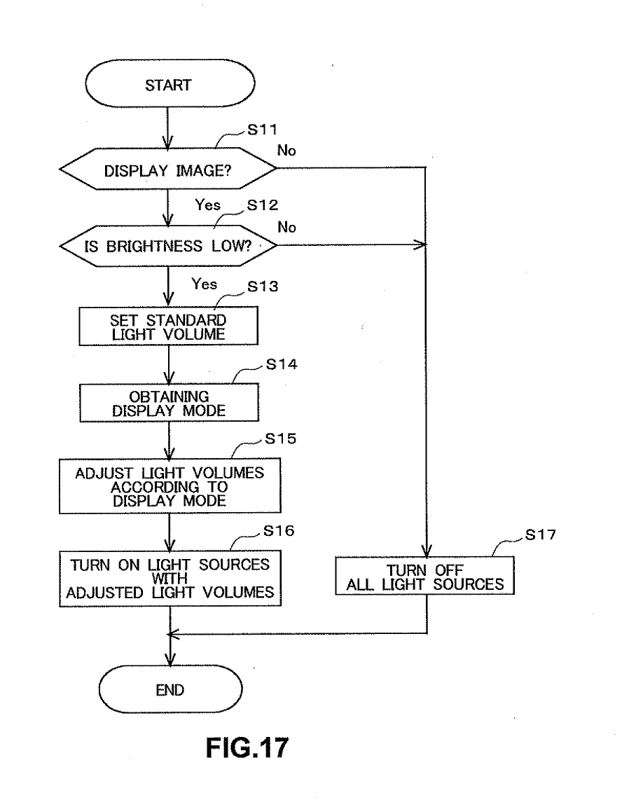

Next described is the process flow to individually adjust the light volumes of the plurality of light sources 60. FIG. 17 shows the process flow describing how the light controller 12 adjusts the light volumes of the light sources 60. The process is repeatedly implemented by the light controller 12.

First, it is judged that the display 21 is in a status to display the display image showing the status of the surrounding areas of the vehicle 9 (a step S11). Concretely, it is judged that the operating mode is a mode other than the navigation mode M0 (one of the surrounding confirmation mode M1, the front mode M2 and the back mode M3). When the operating mode is navigation mode M0 (in case of No at the step S11), all light sources 60 are turned off because the lighting by the auxiliary lighting unit 6 is not necessary (a step S17)

When the operating mode is different from the navigation mode M0 (Yes at the step S11), it is judged whether or not the brightness of the surrounding areas of the vehicle is low enough to require lighting by the auxiliary lighting unit 6. For the brightness of the surrounding areas of the vehicles, the average brightness of shot images captured by the shooting unit 5 is used. The average brightness of the shot images is derived by the acquiring unit 13 and then judged whether it is the predetermined value (“150” for example) or less (a step S12). When the average brightness of the shot images is higher than the predetermined threshold value (No at the step S12), all the light sources 60 are turned off because lightning by the auxiliary lighting unit 6 are unnecessary (the step S17).

On the other hand, when the average brightness of the shot image is lower than the predetermined value (in case of Yes at the step S12), respective standard light volumes of plurality of light sources 60 are set based on brightness of the surrounding areas of the vehicle. Concretely, the standard light volume table 4b stored in the non-volatile memory 40 is referred to and respective standard current values of the plurality of light sources 60 are obtained based on the average brightness of the shot images (a step S13).

Next, the display mode which is presently selected is obtained (a step S14). The respective standard light volumes of the plurality of light sources 60 are adjusted according to the display mode and the controlled light volumes are determined (a step S15). Concretely, the light volume adjusting table 4 stored in the non-volatile memory 40 is referred to and the standard current values are increased and decreased according to the display mode is implemented, or the standard current values are maintained to determine the controlled current values.

Subsequently, the light controller 12 outputs signals to each current changing units 61a, 62a and 63a in the light source driving unit 69 so that individual current values of light sources 60 become equal to controlled current values. In this way, light sources 60 emit with individually adjusted controlled light volumes for respective light sources 60 (a step S16).

As explained above, in the image display system 120 in the embodiment, the respective light volumes of the plurality of light sources 60 are individually adjusted according to surrounding areas of the vehicle indicated as the subject images in the display images on the display 21. Thus, only the light volumes of a necessary part of the light sources 60 can be increased. Therefore, all of the plurality of light sources 60 are not necessary to be emitted at maximum capacity constantly, so that consumed electric power can be reduced. The degradation of the light sources 60 is restricted and its durability can be improved.

According to the display mode, the light volume of a part of light sources 60 among the plurality of light sources 60 is increased from the standard light volume and the light volume of another of the light sources 60 is decreased from the standard light volume, whereby contrast between the area lit by the light sources 60 with increased light volume and the area lit by the light sources 60 with decreased light volume becomes high, so that a part of areas of lateral area SA to call user's attention (area lit by light sources 60 with increased light volume) can be highlighted. If the light volume of a part of light sources 60 is increased, the light volume of another of the light sources 60 is decreased. Therefore the total value of electric current flown into the one side camera unit 70 is restricted, so that the increase in costs of the electric wiring and electric parts etc. can be prevented.

In addition, the light volumes of light sources 60 can be adjusted to the appropriate values according to the brightness of the surrounding areas of the vehicle, so that useless lightning is omitted and consumed power can be effectively reduced.

### 2. Second Embodiment

Next described is the second embodiment. The composition and process of an image display system in the second embodiment are almost the same as the ones in the first embodiment although a part of them are different. The differences with the first embodiment are mainly explained below.

In an own vehicle confirmation mode M22 in the second embodiment, a viewpoint of virtual viewpoint VP for a composite image FP4 is shifted in response to driver's operation of an indicator switch of a direction indicator 85.

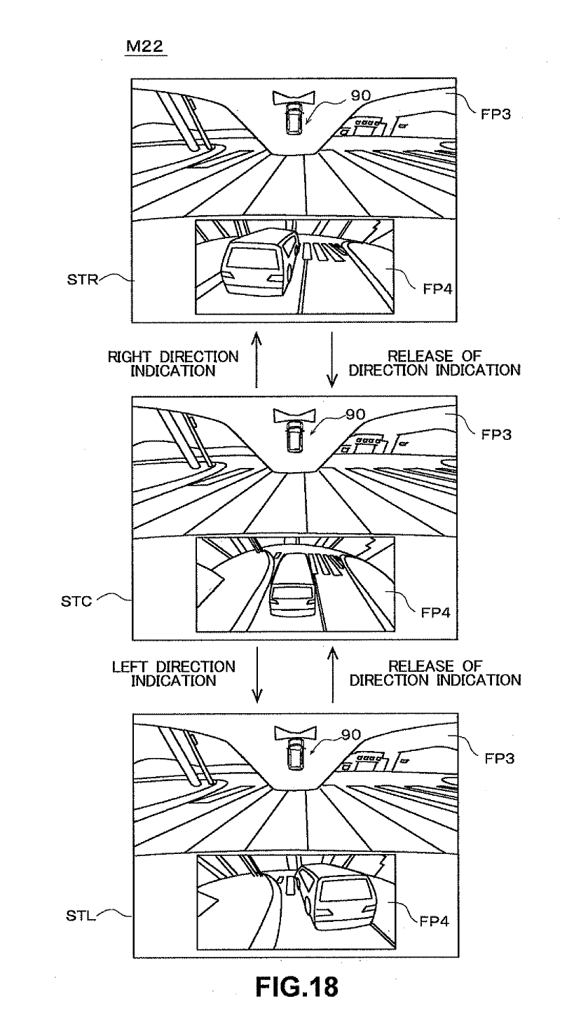

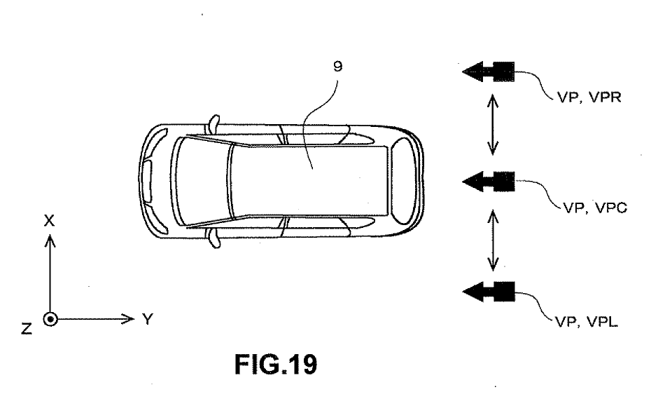

FIG. 18 shows state transition of screens in the own vehicle confirmation mode M22. FIG. 19 shows positional transition of virtual viewpoint VP. When turn signals sent out from the direction indicator 85 are OFF, that is, when there is no direction indication, the view position of the virtual viewpoint VP is fixed at a substantial center in a width direction of and behind the vehicle 9, that is, at VPC (refer to FIG. 19) and its view direction is headed in a forward direction of the vehicle 9. Thus, as shown in a status STC in FIG. 18, the composite image FP4 substantially equally showing both lateral areas of the vehicle 9 is displayed as a display image on a display 21.

On the other hand, when the turn signals sent out from the direction indicator 85 are ON, that is, when there is direction indication, the view direction is maintained in a forward direction of the vehicle 9 as it is and the view position is shifted to the direction indicated by the turn signals.

Concretely, when the turn signals indicate a left direction, the view position of the virtual viewpoint VP is fixed at VPL on the left side of the vehicle 9 (refer to FIG. 19). Thus, as shown in the state STL in FIG. 18, the composite image FP4 showing the lateral area in the left direction indicated by the turn signals of the direction indicator 85 is displayed larger than the lateral area in the right direction as the display image on the display 21.

When the turn signals indicate right direction, the viewpoint of the virtual viewpoint VP is fixed at VPR on the right side of the vehicle 9 (refer to FIG. 19). Thus, as shown in the state STR in FIG. 18, the composite image FP4 showing the lateral area in the right direction indicated by the turn signals of the direction indicator 85 is displayed larger than the lateral area in the left direction as the display image on the display 21.

In the direction indicated by the direction indicator 85, there is strong possibility that the vehicle 9 will sideswipe obstacles when changing direction and pulling itself to the road. Accordingly, displaying the lateral area in the direction indicated by the turn signals of the direction indicator 85 at a larger size than the one in other direction helps call user's (typically driver's) attention to the obstacles and prevents collision between the vehicle and the obstacles. When the direction indication is released, the screen is back to the status that displays the composite image FP4 substantially equally showing right and left lateral areas of the vehicle 9.

In the embodiment, when the direction indication is given, the light volumes of three light sources 60 at a side camera unit 70, disposed on a side of the direction indication, are set to be greater than the ones disposed on an opposite side from the direction indication.

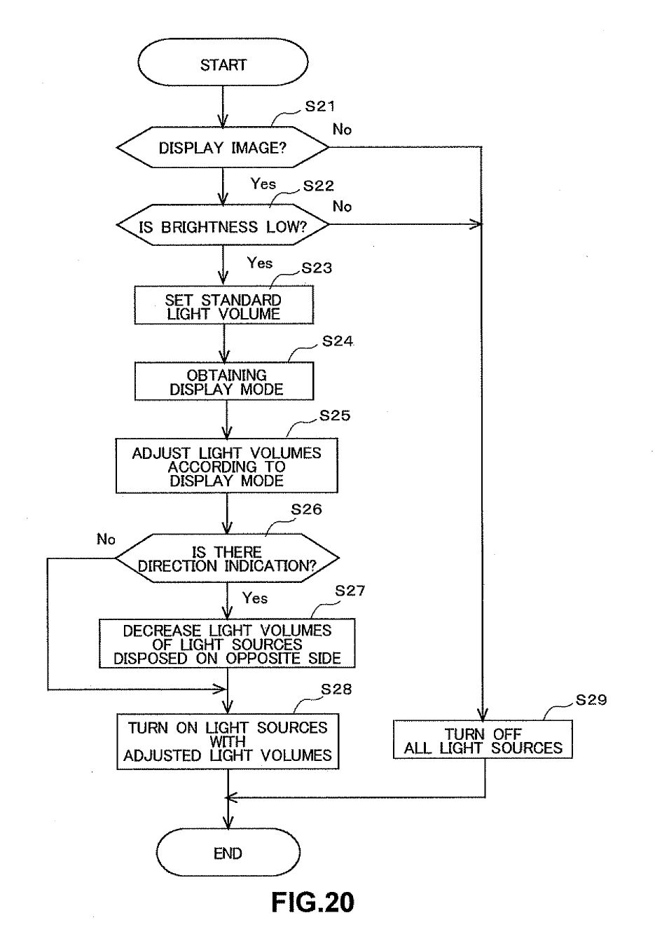

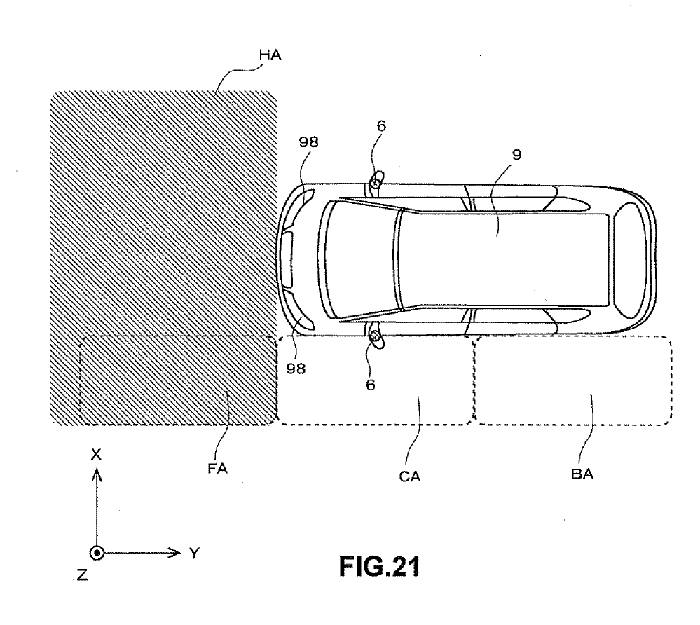

FIG. 20 shows the process flow adjusting the light volumes of the light sources 60 in the second embodiment.

The process between steps S21 and S25 and a step S29 described in FIG. 20 is the same as the one between steps S11 and S15 and a step S17. Thus, respective controlled light volumes (more properly, controlled current value) are determined according to a display mode at a completion of the step S25.

After the completion of the step S25, it is judged whether the display mode is the own vehicle confirmation mode M22 and also there is the direction indication or not (a step S26). The presence or absence of the direction indication is judged by the turn signals. In a case where there is no direction indication even if the display mode is the own vehicle confirmation mode M22 or other (No at the step S26), each of light sources 60 is controlled to emit at the controlled light volume determined at the step S25 (a step S28).

On the other hand, in a case where the display mode is the own vehicle confirmation mode M22 and also there is the direction indication (Yes at a step S26), all controlled light volumes of three light sources 60 disposed on an opposite side from the direction indication are redetermined to be decreased ones from a standard light volume. In addition, the controlled light volumes of the three light sources 60 disposed on a side of the direction indication are maintained as they are (a step S27). Each of light sources 60 is controlled to be emitted at a controlled light volume that has been redetermined (the step S28).

Therefore, only the controlled light volumes of a front light source 61 and a central light source 63 on a side of the direction indication are increased from the standard light volume and the controlled light volume of another of the light sources 60 is decreased from the standard light volume. As a result, the light volumes of light sources 60 on a side of the direction indication become greater than the ones in an opposite direction, so that user's (deriver's) attention can be called to the direction where there is high possibility that the user will sideswipe obstacles. In this case, for the light sources 60 in an opposite direction from one of the instructed direction, the controlled light volume is decreased, but not turned to off. Thus, if obstacles that may be sideswiped exist in an opposite direction from one indicated by the direction indicator, a user can recognize the obstacle.

In the embodiment, in the own vehicle confirmation mode M22 alone, the light volumes of the light sources 60 are adjusted according to a direction of the instructed direction. However, as with other display modes, light volumes of three light sources 60 on a side of the direction indication can be set to be greater than the ones in opposite direction from one of the instructed direction.

### 3. Third Embodiment

Next described is the third embodiment. The composition and process of an image display system in the third embodiment are almost the same as the ones in the first embodiment although a part of them are different. The differences with the first embodiment are mainly explained below.

Three light sources 60 disposed in a one side camera unit 70 light a front area FA, a central area CA and a rear area BA as shown in FIG. 6. Headlights installed in a vehicle 9 as a standard can light the front area. FA among them.

FIG. 21 shows an area where headlights 98 of a vehicle 9 can light. Cross-hatching in the figure shows an area HA where headlights 98 can light so that it helps capture images with enough brightness (e.g. 0.5 lux or more) even in a dark surrounding environment. As shown in the figure, the front area FA is included in the area HA where the headlights 98 can light. Accordingly, when the headlights 98 are turned on, the necessity to increase the light volume for the front area FA is low. Thus, in this embodiment, in a case where the headlights 98 are turned on, a controlled light volume of a front light source 61 is decreased from a standard light volume.

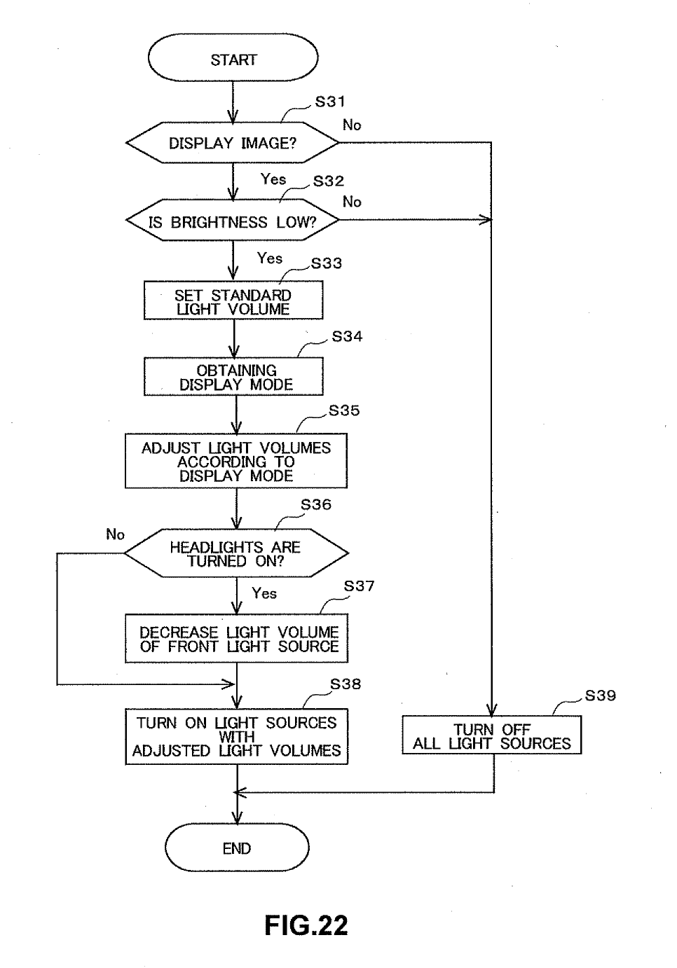

FIG. 22 shows a process flow for adjusting the light volumes of light sources 60 in the third embodiment.

The processes between steps S31 and S35 and a step S39 described in FIG. 22 are the same as the one between steps S11 and S15 and a step S17 described in FIG. 17. Thus, respective controlled light volumes (more properly, controlled current values) are determined according to a display mode at a completion of the step S35.

After the completion of the step S35, it is judged whether the headlights 98 are turned on or not (a step S36). The lighting status of the headlights 98 is judged by signals from a lighting control apparatus 84. In a case where the headlights 98 are turned off (No at the step S36), each of light sources 60 is controlled to emit at the controlled light volume determined at the step S35 (a step S38).

On the other hand, in a case where the headlights 98 are turned on (Yes at the step S36), a controlled light volume of the front light source 61 is redetermined to be decreased ones from a standard light volume. In addition, the controlled light volumes of the light sources 60 other than the front light source 61 are maintained as they are (a step S37). Each of light sources 60 is controlled to be emitted at a controlled light volume that has been redetermined (the step S38).

In a case where the headlights 98 are turned on as described above, a controlled light volume of the front light source 61 is decreased from a standard light volume, so that useless lightning is omitted and consumed power can be effectively reduced. In this embodiment, only the lighting status of the headlights 98 among the driving lighting system is considered. However, the light volume of each of light sources 60 can be adjusted in light of the lighting status of other driving lighting system such as brake lights and tail lights.

### 4. Alternative Embodiment

Some embodiments in the invention have been described so far. The invention is not limited to the above embodiments, but includes various embodiments. These modifications are described below. Every embodiment described in the above and below can be optionally combined with others.

In the above embodiments, the respective light volumes of a plurality of light sources are individually adjusted according to the display mode. The operating mode is changed according to the running status of the vehicle such as the shift lever position and the running speed and the display mode is changed according to the operating mode, so that the technology in the above embodiments can be called a technology that the respective light volumes of plurality of light sources are individually adjusted according to the running status of the vehicle. The respective light volumes of plurality of light sources can be individually adjusted in light of the running status of the vehicle irrespective of display mode. For example, it is conceivable that the controlled light volume of the front light source 61 is increased from the standard light volume (the light volume of another of the light sources 60 are decreased from the standard light volume) when the shift lever position is “D (drive)” and that the controlled light volume of the rear light source 62 is increased from the standard light volume (the light volume of another of the light sources 60 are decreased from the standard light volume) when the shift lever position is “R (reverse)”. In addition, when the running speed is over the predetermined speed, the controlled light volume of the front light source 61 is increased from the standard light volume (the light volume of another of the light sources 60 are decreased from the standard light volume) in order to make the driver concentrate on the direction where the vehicle travels. When the running speed is below the predetermined one, it is conceivable that the controlled light volumes of all the light sources 60 are maintained at the standard light volume because it is often required for a driver to confirm the surroundings of the vehicle.

The light sources explained in the above embodiments, where the controlled light volume is decreased from the standard light volume, can be turned off.

In addition, in the above embodiments, the standard light volume is set based on the surrounding brightness of the vehicle. However, the standard light volume can be a predetermined specific value.

In the embodiments mentioned above, the average brightness of the shot images is utilized as a value indicating the brightness of the surrounding areas of the vehicle. However, an illuminance sensor sensing illuminance of the surrounding areas of the vehicle may be installed to utilize the detected results by the illuminance sensor as values indicating the brightness of the surrounding. The illuminance sensor can be installed on an upper center of a windshield or on a dashboard of a vehicle.

In the embodiments mentioned above, the lateral areas of the vehicle are defined as the particular areas of the surrounding areas of the vehicle, lit by plurality of light sources. However, the particular areas are not limited to the lateral areas of the vehicle but can be applied to arbitrary surrounding areas of the vehicle. It is effective to set the lateral areas as specific areas like the above embodiments because images showing images showing lateral areas that are hard for drivers to confirm and also hard even for a driving lighting system to light up can be displayed even in a dark surrounding areas of the vehicle. In addition, in the above embodiments, right and left lateral areas of the vehicle are specified as particular areas, only one side lateral area (for example, only lateral area on the opposite side of a driver seat that tend to be a blind spot) can be set as a particular area.

In the above embodiments, the image processing apparatus 100 and the navigation apparatus 20 are described as different ones. However, the both apparatus can be disposed in the same housing and composed as an all-in-one unit.

In the above embodiments, a display apparatus that displays an image generated by the image processing apparatus 100 is explained as the navigation apparatus 20. However, a general display apparatus without specific functions such as navigation functions can be used.

The functions implemented by the controller 1 of the image processing apparatus 100 are described in the above embodiments. However, a part of functions thereof can be implemented by a controller 23 of the navigation apparatus 20.

Signals received by the signal receiving unit 41 are described in the above embodiments. However, a part of or all functions can be received by the navigation apparatus 20. In this case, it is recommended that signals received by the navigation apparatus 20 are further received by a navigation communication unit 42 to be entered into the controller 1 of the image processing apparatus 100.

In the above embodiments, signals representing the direction of a direction indication given from a driver of the vehicle are received by a direction indicator 85. However, the signals can be received from other parts. For example, the driver's view points are detected from photographed images of driver's eyes, whereby apparatus derives a direction from driver's instruction from the results. Then signals representing the corresponding direction can be received from the apparatus.

In the above embodiments, it is explained that each function is performed by software as a result of performance of arithmetic processing of a CPU in accordance with a program. However, a part of the functions may be perforated by an electrical hardware circuit. Contrarily, a part of functions that are explained to be performed by a hardware circuit in the above embodiments may be performed by software.

While the invention has been shown and described in detail, the foregoing description is in all aspects illustrative and not restrictive. It is therefore understood that numerous other modifications and variations can be devised without departing from the scope of the invention.

What is claimed is:

1. An on-vehicle lighting apparatus that provides illumination to assists an image-generating apparatus in shooting, the image-generating apparatus generating composite images including at least a part of surrounding areas of a vehicle which is viewed from virtual viewpoints, based on shot images obtained by shooting of the surrounding areas of the vehicle by plural cameras, the image-generating apparatus causing a display apparatus to display at least one image out of the shot images and the composite images as a display image, the on-vehicle lighting apparatus comprising:
a plurality of light sources that respectively light plural areas obtained by dividing a particular area of the surrounding areas of the vehicle; and
an adjusting unit that individually adjusts respective light volumes of the plurality of light sources according to the surrounding areas of the vehicle included in the display image.

2. The on-vehicle lighting apparatus according to claim 1, wherein
the adjusting unit increases a light volume of a part of the plurality of light sources from a standard light volume and decreases a light volume of another of the plurality of light sources from the standard light volume.

3. The on-vehicle lighting apparatus according to claim 1, further comprising:
an obtaining unit that obtains brightness of the surrounding areas of the vehicle, wherein
the adjusting unit adjusts the respective light volumes of the plurality of light sources according to the brightness of the surrounding areas of the vehicle obtained by the obtaining unit.

4. The on-vehicle lighting apparatus according to claim 1, further comprising:
a receiving unit that receives signals representing a lighting status of a drive lighting apparatus used for running of the vehicle, wherein
the adjusting unit adjusts the respective light volumes of the plurality of light sources according to the lighting status received by the receiving unit.

5. The on-vehicle lighting apparatus according to claim 1, further comprising:
a receiving unit that receives signals representing a direction of direction indication given from a driver of the vehicle, wherein
the plurality of light sources are disposed on each of right and left sides of the vehicle, and
when the direction indication is given, the adjusting unit makes light volumes of the plurality of light sources disposed on the side of the direction indication, greater than light volumes of the plurality of light sources disposed on an opposite side from the direction indication.

6. An image processing apparatus installed in a vehicle, the image processing apparatus comprising:
an image-generating apparatus that generates composite images including at least a part of surrounding areas of the vehicle which is viewed from virtual viewpoints, based on shot images obtained by shooting of the surrounding areas of the vehicle by plural cameras; and
an on-vehicle lighting apparatus that provides illumination to assist the image-generating apparatus in shooting, wherein
the image-generating apparatus causes a display apparatus to display at least one image out of the shot images and the composite images as a display image, and
the on-vehicle lighting apparatus includes:
a plurality of light sources that respectively light plural areas obtained by dividing a particular area of the surrounding areas of the vehicle; and
an adjusting unit that individually adjusts respective light volumes of the plurality of light sources according to the surrounding areas of the vehicle included in the display image.

7. An image display system installed in a vehicle, the image display system comprising:
an image-generating apparatus that generates composite images including at least a part of surrounding areas of the vehicle which is viewed from virtual viewpoints, based on shot images obtained by shooting of the surrounding areas of the vehicle by plural cameras;
an on-vehicle lighting apparatus that provides illumination to assist the image-generating apparatus in shooting; and
a display apparatus that displays at least one image out of the shot images and the composite images as a display image, wherein
the on-vehicle lighting apparatus includes:
a plurality of light sources that respectively light plural areas obtained by dividing a particular area of the surrounding areas of the vehicle; and
an adjusting unit that individually adjusts respective light volumes of the plurality of light sources according to the surrounding areas of the vehicle included in the display image.

8. A lighting method for providing illumination to assist an image-generating apparatus in shooting, the image-generating apparatus generating composite images including at least a part of surrounding areas of a vehicle which is viewed from virtual viewpoints, based on shot images obtained by shooting of the surrounding areas of the vehicle by plural cameras, the method comprising the steps of:
(a) displaying at least one image out of the shot images and the composite images as a display image on a display apparatus; and
(b) individually adjusting respective light volumes of a plurality of light sources that respectively light plural areas obtained by dividing a particular area of the surrounding areas of the vehicle according to the surrounding areas of the vehicle included in the display image.

9. The lighting method according to claim 8, wherein
the step (b) increases a light volume of a part of the plurality of light sources from a standard light volume and decreases a light volume of another of the plurality of light sources from the standard light volume.

10. The lighting method according to claim 8, further comprising the step of:
obtaining brightness of the surrounding areas of the vehicle, wherein
the step (b) adjusts the respective light volumes of the plurality of light sources according to the obtained brightness of the surrounding areas of the vehicle.

11. The lighting method according to claim 8, further comprising the step of:
receiving signals representing a lighting status of a drive lighting apparatus used for running of the vehicle, wherein
the step (b) adjusts the respective light volumes of the plurality of light sources according to the received lighting status.

12. The lighting method according to claim 8, further comprising the step of:
receiving signals representing a direction of direction indication given from a driver of the vehicle, wherein
the plurality of light sources are disposed on each of right and left sides of the vehicle, and
when the direction indication is given, the step (b) makes light volumes of the plurality of light sources disposed on the side of the direction indication, greater than light volumes of the plurality of light sources disposed on an opposite side from the direction indication.
